(19) United States
(12) Patent Application Publication
(10) Pub. No.: US 2026/0195142 A1
(43) Pub. Date: Jul. 9, 2026

(54) APPARATUS AND METHOD FOR CONTROLLING OPERATION OF A COMPUTING SYSTEM

(71) Applicant: C&J Innovations, LLC, Dallas, TX (US)

(72) Inventors: Colleen Bowler, Dallas, TX (US); Jeanne Hurlbert, Dallas, TX (US)

(73) Assignee: C&J Innovations, LLC, Dallas, TX (US)

(21) Appl. No.: 19/555,764

(22) Filed: Mar. 3, 2026

Related U.S. Application Data
(63) Continuation-in-part of application No. 18/096,360, filed on Jan. 12, 2023.

(51) Int. Cl. G06F 9/445; G06N 20/00

(52) U.S. Cl. CPC G06F 9/44505; G06N 20/00

(57) ABSTRACT

An apparatus for controlling operation of a computing system includes a processor and a memory containing instructions that configure the processor to obtain input data associated with multiple system stages, generate fixed-dimensional state vectors for each stage, and determine state scores using a machine-learning model. The apparatus compares state scores to determine a state distance between stages and controls system operations, such as visual interface configuration, based on the state distance. The state vectors include normalized parameters corresponding to machine-defined state variables, enabling the apparatus to evaluate and control system stages in a flexible and adaptive manner.

### CROSS-REFERENCE TO RELATED APPLICATIONS

This application is a continuation-in-part of U.S. non-provisional patent application Ser. No. 18/096,360, filed on Jan. 12, 2023, and entitled “AN APPARATUS AND METHOD FOR GENERATING A VIABILITY COACHING PLAN,” the entirety of which is incorporated herein by reference.

### FIELD OF THE INVENTION

The present invention generally relates to the field of solution simulation and automation. In particular, the present invention is directed to an apparatus and method for controlling operation of a computing system.

### BACKGROUND

Previous approaches to controlling operation of computing systems have relied on manual configuration and static rules to manage system stages. However, these methods have been inflexible and unable to adapt to changing system conditions, leading to suboptimal system performance and user experience. Previous approaches to controlling operation of computing systems have been unable to effectively capture complex system dynamics and adapt to changing system conditions. However, none of previous approaches have provided a comprehensive solution that improves controlling operation of computing systems.

### SUMMARY OF THE DISCLOSURE

In some aspects, the techniques described herein relate to an apparatus for controlling operation of a computing system, wherein the apparatus includes at least a processor, and a memory communicatively connected to the at least a processor, wherein the memory contains instructions configuring the at least a processor to obtain input data associated with a plurality of system stages, wherein the plurality of system stages includes a now stage and at least one goal stage, generate, for each of the plurality of system stages, a state representation including a fixed-dimensional state vector, wherein the fixed-dimensional state vector includes a plurality of normalized parameters corresponding to a plurality of machine-defined state variables, determine a state score corresponding to each of the plurality of system stages as a function of the fixed-dimensional state vector associated with each of the plurality of system stages using a state score machine-learning model, determine a state distance between at least two system stages based on a comparison of the state scores of the plurality of system stages, and control at least a system operation as a function of the state distance, wherein the at least a system operation includes controlling configuration of a visual interface.

In some aspects, the techniques described herein relate to a method of controlling operation of a computing system, wherein the method includes obtaining, using at least a processor, input data associated with a plurality of system stages, wherein the plurality of system stages includes a now stage and at least one goal stage, generating, using the at least a processor and for each of the plurality of system stages, a state representation including a fixed-dimensional state vector, wherein the fixed-dimensional state vector includes a plurality of normalized parameters corresponding to a plurality of machine-defined state variables, determining, using the at least a processor, a state score corresponding to each of the plurality of system stages as a function of the fixed-dimensional state vector associated with each of the plurality of system stages using a state score machine-learning model, determining, using the at least a processor, a state distance between at least two system stages based on a comparison of the state scores of the plurality of system stages, and controlling, using the at least a processor, at least a system operation as a function of the state distance, wherein the at least a system operation includes controlling configuration of a visual interface.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a block diagram of an exemplary embodiment of an apparatus for generating a viability coaching plan;

FIG. 1B is a block diagram of an exemplary embodiment of an apparatus for controlling operation of a computing system;

FIG. 2 is a block diagram of an exemplary embodiment of a machine-learning module;

FIG. 3 is a block diagram illustrating an exemplary embodiment of a neural network;

FIG. 4 is a block diagram illustrating an exemplary embodiment of a node in a neural network;

FIG. 5 is a schematic diagram illustrating an exemplary embodiment of a fuzzy inferencing system;

FIG. 6A is a schematic diagram of an exemplary embodiment of a method of generating a viability coaching plan;

FIG. 6B is a schematic diagram of an exemplary embodiment of a method of controlling operation of a computing system; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses for and methods of controlling operation of a computing system, wherein the apparatus includes at least a processor, and a memory communicatively connected to the at least a processor, wherein the memory contains instructions configuring the at least a processor to obtain input data associated with a plurality of system stages, wherein the plurality of system stages includes a now stage and at least one goal stage, generate, for each of the plurality of system stages, a state representation including a fixed-dimensional state vector, wherein the fixed-dimensional state vector includes a plurality of normalized parameters corresponding to a plurality of machine-defined state variables, determine a state score corresponding to each of the plurality of system stages as a function of the fixed-dimensional state vector associated with each of the plurality of system stages using a state score machine-learning model, determine a state distance between at least two system stages based on a comparison of the state scores of the plurality of system stages, and control at least a system operation as a function of the state distance, wherein the at least a system operation includes controlling configuration of a visual interface.

Conventional computerized planning, evaluation, and decision-support systems that employ machine-learning techniques are technically limited when required to concurrently evaluate multiple alternative future states for a single entity. In particular, such systems typically generate outcomes sequentially, rely on repeated retraining or recomputation of intermediate features, or overwrite previously learned representations when new data is introduced. These approaches result in excessive computational overhead, unstable inference outputs, inefficient memory utilization, and degraded system scalability.

Additionally, conventional systems present system-generated outcomes through static or sequential user interfaces that require repeated user navigation, manual filtering, or mental comparison to understand relationships between alternative states. Such interfaces do not alter their internal behavior based on machine-computed relationships and therefore increase interaction burden while failing to scale as the number of system-generated states increases. These deficiencies represent technical limitations of computerized systems, including limitations in machine-learning model operation, memory management, execution flow, and interface behavior, rather than problems of human judgment or decision-making.

The present disclosure addresses the foregoing limitations by introducing a computer-implemented architecture that maintains concurrent, persistent, machine-readable state representations corresponding to alternative system-defined future states, applies a state distance machine-learning model configured to operate on normalized state representations without retraining for each comparison, incrementally updates state representations while preserving previously learned relationships and dynamically controls system output behavior, including user interface organization and navigation, based on machine-computed state relationships. These techniques improve the functioning of the computing system itself by reducing retraining requirements, lowering computational and memory overhead, stabilizing inference behavior, and reducing user interaction steps required to interpret complex system outputs.

Aspects of the present disclosure are also directed to systems for and methods of generating a viability coaching plan, wherein the apparatus includes at least a processor and a memory communicatively connected to the processor, wherein the memory containing instructions configuring the processor to receive a user profile from a user, determine an expansion plan as a function of the user profile, determine a walkaway plan as a function of the user profile, and generate a viability coaching plan as a function of the expansion plan and the walkaway plan. Exemplary embodiments illustrating aspects of the present disclosure are described below in the context of several specific examples.

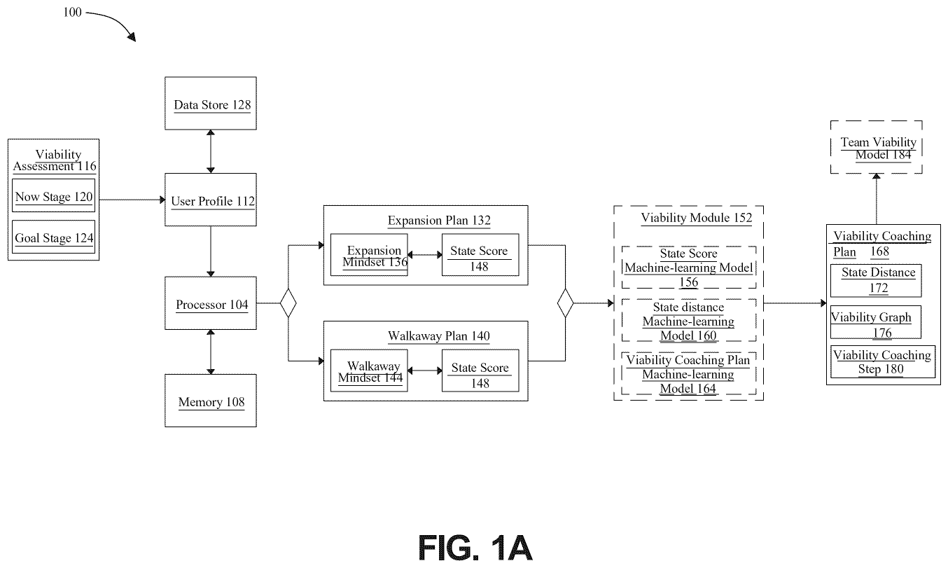

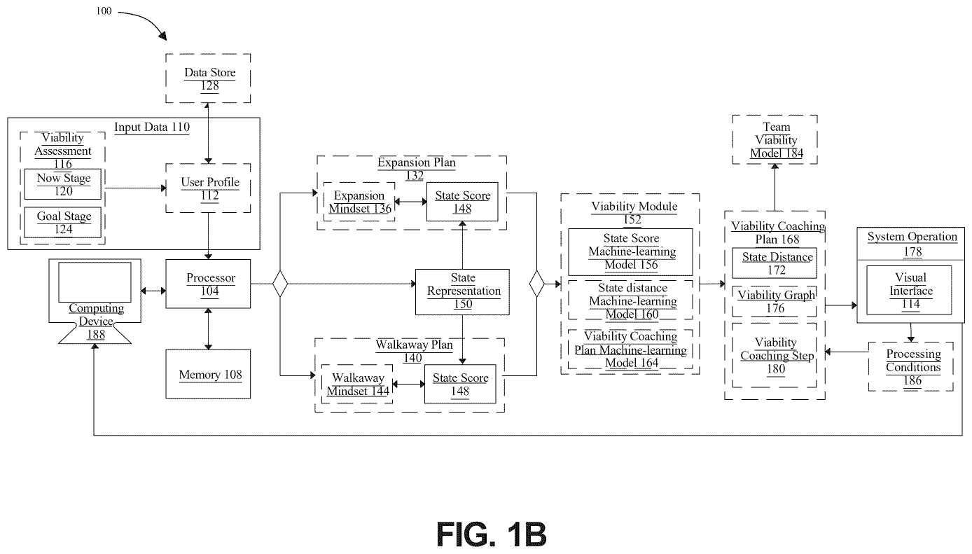

Referring now to FIGS. 1A-B, exemplary embodiments of an apparatus 100 for generating a viability coaching plan and/or controlling operation of a computing system are illustrated. Apparatus 100 may include a processor 104 and a memory 108 communicatively connected to the processor 104. Memory 108 includes a plurality of instructions configuring the processor to do various tasks, as described below. Processor 104 may include any computing device as described in this disclosure, including without limitation a microcontroller, microprocessor, digital signal processor (DSP) and/or a system on a chip (SoC), as described in this disclosure. Computing devices may include, be included in, and/or communicate with a mobile device, such as a mobile telephone or smartphone. Processor 104 may include a single computing device operating independently, or may include two or more computing devices operating in concert, in parallel, sequentially, or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card or a LAN card), a modem, and any combination thereof. Examples of a network include, but are not limited to, a wide area network (e.g., the Internet, an enterprise network), a local area network (e.g., a network associated with an office, a building, a campus or another relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices that may operate in parallel, in series, redundantly, or in any other manner used for distribution of tasks or memory between computing devices. Processor 104 may be implemented using a “shared nothing” architecture in which data are cached at the worker or in an embodiment; this may enable scalability of apparatus 100 and/or computing device.

With continued reference to FIGS. 1A-B, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively, using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively-addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIGS. 1A-B, processor 104 may perform determinations, classification, and/or analysis steps, methods, processes, or the like, as described in this disclosure using machine-learning processes. A “machine-learning process,” as used in this disclosure, is an automated process that uses a body of data known as “training data” and/or a “training set” (described further below in this disclosure) to generate an algorithm that will be performed by a processor 104/module to produce outputs given data provided as inputs; this is in contrast to a non-machine-learning software program in which the commands to be executed are determined in advance by a user and written in a programming language. Machine-learning processes may utilize supervised, unsupervised, lazy-learning processes and/or neural networks, described further below.

With continued reference to FIGS. 1A-B, as used in this disclosure, “communicatively connected” means connected by way of a connection, attachment, or linkage between two or more relata, which allows for reception and/or transmittance of information between them. For example, and without limitation, this connection may be wired or wireless, direct, or indirect, and between two or more components, circuits, devices, apparatuses, and the like, which allows for reception and/or transmittal of data and/or signal(s) between them. Data and/or signals may include, without limitation, electrical, electromagnetic, magnetic, video, audio, radio and microwave data and/or signals, combinations thereof, and the like, among others. A communicative connection may be achieved, for example and without limitation, through wired or wireless electronic, digital, or analog communication, either directly or by way of one or more intervening devices or components. Further, communicative connection may include electrically coupling or connecting at least an output of one device, component, or circuit to at least an input of another device, component, or circuits, for example, and without limitation, via a bus or other facility for intercommunication between elements of a computing device. Communicative connecting may also include indirect connections via, for example and without limitation, wireless connection; radio communication; a low-power wide area network; optical communication; magnetic, capacitive, or optical coupling; and the like. In some instances, the terminology “communicatively coupled” may be used in place of “communicatively connected” in this disclosure.

With continued reference to FIGS. 1A-B, processor 104 is configured to obtain input data 110 associated with a plurality of system stages, wherein the plurality of system stages includes a now stage and at least one goal stage. For purposes of this disclosure, “input data” is data used by the computing system as an input to one or more processing operations performed by processor 104 during execution of the system. As used in this disclosure, a “system stage” is a point, period, state, or other type of step defined by the computing system for evaluating, processing, or representing system behavior or user-related information. In some cases, system stage may include stages associated with a viability assessment, stages associated with system operation over time, or other system-defined stages. In embodiments, the input data 110 may be accessed, received, or generated by the computing system and may correspond to system-defined information used to construct, update, or evaluate internal representations of the plurality of system stages. In embodiments, each system stage may represent a distinct system-defined point, period, or evaluation state used by processor 104 to model, analyze, or compare system behavior or user-related information. The now stage may correspond to a current system stage reflecting presently available input data, while the at least one goal stage may correspond to a prospective or alternative system stage defined by different input data, system conditions, or evaluation parameters. Processor 104 may associate input data 110 with a respective system stage by mapping the input data 110 to machine-defined state variables corresponding to that stage. In embodiments, the processor 104 may concurrently maintain input data 110 for multiple system stages in memory 108, thereby enabling generation and evaluation of multiple state representations without overwriting previously obtained data. In embodiments, obtaining input data 110 may include retrieving stored data from memory, receiving data via a communication interface, or generating data through execution of one or more processing routines. The input data 110 may be obtained synchronously or asynchronously and may be updated over time as system conditions change, such that processor 104 can reevaluate relationships between the now stage and the at least one goal stage based on newly obtained input data.

With continued reference to FIGS. 1A-B, processor 104 may be configured to receive a user profile 112 from a user. As used in this disclosure, “receive” means to accept, collect, or otherwise receive input from a user and/or a device. As used in this disclosure, a “user” may include an individual, a family, an enterprise, an entity, and/or other groups of people. As used in this disclosure, “user profile” is a collection of data and/or information about a plurality of user-related data, wherein the user-related information is related to a user. In an embodiment, a user profile and/or user-related data may be obtained using a user device associated with a user. A “user device,” for the purpose of this disclosure, is any additional computing device, such as a mobile device, laptop, desktop computer, or the like. In a non-limiting embodiment, user device may be a computer and/or smart phone operated by a user in a remote location. User devices may include, without limitation, a display; the display may include any display as described in the entirety of this disclosure, such as a light emitting diode (LED) screen, liquid crystal display (LCD), organic LED, cathode ray tube (CRT), touch screen, or any combination thereof. In a non-limiting embodiment, a user device may include a visual interface 114 configured to display any information from apparatus 100 and/or computing device. A visual interface, as disclosed here, will be described in further detail below. In some embodiments, user-related data may be in various format described below. Additionally, or alternatively, user-related data may be present in any data structure described below in this disclosure. In an exemplary embodiment and without limitation, user-related data may include any personal information related to the user. In some cases, personal information may include, without limitation, a user's name, age, gender, identification, profession, experience in profession, geographical information, family information, employer, and the like. Additionally, or alternatively, user-related data may also include any finance information related to a user. In exemplary embodiments, finance information may include, without limitation, assets, income, expenses, debts, and the like. Additionally, or alternatively, user-related data may include any health information related to a user. In exemplary embodiments, health information may include, without limitation, wellness, insurance, medical records, disease records, lifestyle, and the like. In a non-limiting example, processor 104 may receive a user profile 112 in a text file format, wherein the user profile 112 may include a user's personal information such as, without limitation, the user's name, age, gender, home address, and the like

With continued reference to FIGS. 1A-B, in some embodiments, user profile 112 may include user-related data associated with a user's expansion. As used in this disclosure, an “expansion” is a category of data that contains information related to user's accumulation. For example, accumulation may include the collection of either tangible or nontangible objects such as, without limitation, knowledge, assets, experience, and the like. In some cases, expansion may include information such as, without limitation, a user's financial goals, health goals, career goals, and the like. In a non-limiting example, user profile 112 may include a user's expansion, containing information related to the user's financial goals—for instance, a user's expected income and/or savings after five years. In some embodiments, user profile 112 may also include user-related data associated with a user's walkaway. As used in this disclosure, a “walkaway” is a category of data that contains information related to a user's retirement. In some cases, walkaway may include information such as, without limitation, a user's enrollment in a retirement program, a retirement account, retirement age, and the like. In a non-limiting example, user profile 112 may include a user's walkaway, containing information related to a user's retirement account—for instance, an amount of savings in the account.

With continued reference to FIGS. 1A-B, in some embodiments, user profile 112 and/or any data/information described in this disclosure may be present as a vector. As used in this disclosure, a “vector” is a data structure that represents one or more quantitative values and/or measures of home resource data. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, has an identity element that is distributive with respect to vector addition, and is distributive with respect to field addition. Each value of n-tuple of values may represent a measurement or other quantitative value associated with a given category of data, or attribute, examples of which are provided in further detail below. A vector may be represented, without limitation, in n-dimensional space using an axis per category of value represented in n-tuple of values, such that a vector has a geometric direction characterizing the relative quantities of attributes in the n-tuple, as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar and more different where their directions are more divergent—for instance as measured using cosine similarity, computed using a dot product of two vectors. However, vector similarity may alternatively or additionally be determined using averages of similarities between like attributes, or any other measure of similarity suitable for any n-tuple of values, or aggregation of numerical similarity measures for the purposes of loss functions, as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number I of the vector. Scaling and/or normalization may function to make vector comparison independent of absolute quantities of attributes, while preserving any dependency on similarity of attributes.

With continued reference to FIGS. 1A-B, in some embodiments, a user profile 112 and/or any other data/information described in this disclosure may be present as a dictionary. As used in this disclosure, a “dictionary” is a data structure containing an unordered set of key value pairs. In this disclosure, a “key value pair” is a data representation of a data element such as, without limitation, entries of user-related data, any other information within user profile 112, and the like. In some cases, dictionary may be an associative memory, or associative arrays, or the like. In a non-limiting example, a dictionary may be a hash table. In an embodiment, kay value pairs may include a unique key, wherein the unique kay may associate with one or more values. In another embodiment, key value pairs may include a value, wherein the value may associate with a single key. In some cases, each key value pair in a set of key value pairs in a dictionary may be separated by a separator, wherein the separator is an element for separating two key value pairs. In a non-limiting example, a separator may be a comma in between each key value pair in a plurality of key value pairs within a dictionary. In another non-limiting example, a dictionary may be expressed as “{first key value pair, second key value pair},” wherein the first key value pair and the second key value pair may be separated by a comma separator and wherein both the first key value pair and the second key value pair may be expressed as “first/second key: first/second value.” In a further non-limiting example, user profile 112 may be present as a dictionary: “{x: A, y: B},” wherein x may be a first entry corresponding to user-related data from first user A and y may be a second entry may correspond to a second set of user-related data from B. Additionally, or alternatively, a dictionary may include a term index, wherein the term index is a data structure to facilitate fast lookup of entries within a dictionary (i.e., index). In some cases, without limitation, term index may use a zero-based indexing, wherein the zero-based indexing may configure a dictionary to start with index 0. In some cases, without limitation, a term index may use one-based indexing, wherein the one-based indexing may configure a dictionary to start with index 1. In other cases, without limitation, a term index may use a n-based indexing, wherein the n-based indexing may configure a dictionary to start with any index from 0 to n. Further, a term index may be determined/calculated using one or more hash functions. As used in this disclosure, a “hash function” is a function used to map data of arbitrary size to a fixed-size value. In some cases, a fixed-size value may include, but is not limited to, hash value, hash code, hash digest, and the like. In a non-limiting example, user profile 112 may be present as a dictionary containing a plurality of hashes generated using hash function such as, without limitation, an identity hash function, a trivial hash function, a division hash function, word length folding, and the like, wherein each hash of a plurality of hashes may represent a single entry of user-related data within user profile 112.

With continued reference to FIGS. 1A-B, in other embodiments, user profile 112 and/or any other data/information described in this disclosure may be present as any other data structure such as, without limitation, tuple, single dimension array, multi-dimension array, a list, linked list, queue, set, stack, dequeue, stream, map, graph, tree, and the like. In some embodiments, user profile 112 and/or any other data/information described in this disclosure may be present as a combination of more than one above data structure, as described above. In a non-limiting example, user profile 112 may include a dictionary of lists. As will be appreciated by persons having ordinary skill in the art, after having read the entirety of this disclosure, the foregoing list is provided by way of example and other data structures can be added as an extension or improvements of apparatus 100 disclosed herein. In some embodiments, without limitation, data structure may include an immutable data structure, wherein the immutable data structure is a data structure that cannot be changed, modified, and/or updated once the data structure is initialized. In other embodiments, without limitation, data structure may include a mutable data structure, wherein the mutable data structure is a data collection that can be changed, modified, and/or updated once the data structure is initialized. Additionally, or alternatively, user profile 112 and/or any other data/information described in this disclosure may include an electric file format such as, without limitation, txt file, JSON file, XML file, word document, pdf file, excel sheet, image, video, audio, and the like.

With continued reference to FIGS. 1A-B, in some cases, the data within a data structure described above may be sorted in a certain order such as, without limitation, ascending order, descending order, and the like. In a non-limiting example, sorting data within user profile 112 may include using a sorting algorithm. In some cases, a sorting algorithm may include, but is not limited to, selection sort, bubble sort, insertion sort, merge sort, quick sort, heap sort, radix sort, and the like. In a non-limiting example, user-related data within user profile 112 may be sorted in alphabetical order. As will be appreciated by persons having ordinary skill in the art, after having read the entirety of this disclosure, the foregoing list is provided by way of example and other sorting algorithms can be added as an extension or improvement of apparatus 100 disclosed herein.

With continued reference to FIGS. 1A-B, in some embodiments, receiving user profile 112 may include accepting a viability assessment 116 from the user. As used in this disclosure, a “viability assessment” is a set of questions that asks for user related information. In some embodiments, each question within the set of questions of viability assessment 116 may include at least one answer and/or non-answer (such as leaving the question blank). In some cases, a question within viability assessment 116 may include a question that provides a user with an option of selecting a selection from a plurality of response options. In a non-limiting example, viability assessment 116 may include a plurality of multiple-choice questions, wherein each multiple-choice question may include a plurality of response options for the user to select. User selected response option may be the answer to the question. In other embodiments, a question within viability assessment 116 may include a free user input as an answer. As used in this disclosure, a “free user input” is an input that is not defined, or otherwise constrained, by existing answers to a corresponding question. In a further non-limiting embodiment, answers to a question within viability assessment 116 may include text input in addition to existing choice selections. In some embodiments, viability assessment 116 may include questions in a plurality of categories such as, without limitation, a plurality of expansion mindsets 136, a plurality of walkaway mindsets 144, and the like. Expansion mindsets and walkaway mindsets disclosed here will be described in further detail below. In a non-limiting example, viability assessment 116 may include a first set of questions containing questions related to a user's expansion (described above) and a second set of questions containing questions related to user's walkaway (described above). In some embodiments, viability assessment 116 may include a plurality of stages containing a now stage 120 and a goal stage 124. In some cases, system stage may include a point, period, or other type of step in in a viability assessment 116. In a non-limiting example, questions may be asked at plurality of stages. As used in this disclosure, a “now stage” is a time period corresponding to a plurality of questions within viability assessment 116 that ask about a user's current situation. As used in this disclosure, a “goal stage” is a time period in which a plurality of questions within viability assessment 116 asks about user's objective. In some embodiments, a plurality of stages may be arranged in chronological order. In a non-limiting example, viability assessment 116 may include a question regarding the user's expansion, wherein the question may include a now stage 120; for instance, tapping the foundation mindset by exploring whether they have the 5 key protections (life insurance, disability insurance, long-term care insurance, a will and/or trust, and savings). The question may further include a goal stage 124; for instance, tapping the foundation mindset by exploring where the user wants to be regarding having the 5 key protections (life insurance, disability insurance, long-term care insurance, a will and/or trust, and savings). In another non-limiting example, viability assessment 116 may include a question regarding the user's walkaway wherein the question may include a now stage 120; for instance, tapping the wellness mindset by exploring the extent to which the user focuses on healthy habits, such as exercising or watching what they eat” A question may further include a goal stage 124; for instance, tapping the goal stage of the wellness mindset by exploring the degree to which the user wants to focus on health habits, such as exercising and watching what they eat. A plurality of questions may be selected by processor 104 from a question bank. In a non-limiting example, a plurality of questions may be stored in data store 128. In a non-limiting embodiment, viability assessment 116 may be generated by selecting one or more questions from data store 128. In a non-limiting example, viability assessment 116 may include a fixed format such as a user self-evaluation containing a plurality of textual questions to the user. In a non-limiting embodiment, viability assessment 116 may be in other format such as, without limitation, survey, interview, report, events monitoring, and the like thereof. In a further non-limiting embodiment, viability assessment 116 may include a data submission of one or more documentations from the user. As used in this disclosure, a “data submission” is an assemblage of data provided by the user as an input source. In a non-limiting example, data submission may include user uploading one or more user profiles to processor 104. As used in this disclosure, a “documentation” is a source of information. In some cases, documentation may include an electronic document, such as, without limitation, txt file, JSON file, word document, pdf file, excel sheet, image, video, audio, and the like thereof. In a non-limiting example, documentation may include user profile 112, and may be input source of data submission for further processing. Further processing may include any processing step described below in this disclosure. Viability assessment 116 may be accepted through visual interface described below. In a non-limiting example, user may submit viability assessment 116 through a submit button on the visual interface, wherein the submit button may be configured to submit a plurality of answers corresponding to a plurality of questions within the viability assessment 116 and/or request to continue the viability assessment 116 to processor 104.

With continued reference to FIGS. 1A-B, in some embodiments, user profile 112 may be received and/or stored in a data store 128 such as, without a limitation, a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records, as described above. Data entries in a database may be flagged with or linked to one or more additional elements of information, which may be reflected in data entry cells and/or in linked tables, such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIGS. 1A-B, processor 104 is further configured to determine an expansion plan 132 as a function of user profile 112. As used in this disclosure, an “expansion plan” is an evaluation of user's expansion within user profile 112. In some embodiments, expansion plan 132 may be determined based on answers to questions regarding to a user's expansion within viability assessment 116. In some embodiments, expansion plan 132 may include a plurality of expansion mindsets 136 associated with a plurality of state scores 148. As used in this disclosure, an “expansion mindset” is a set of attitudes for improving a user's expansion, as described above. Improving a user's expansion includes increasing a user's joy and quality of life during the user's development (i.e., accumulation) phase, helping the user navigate their future plans, and the like. In a non-limiting example, a plurality of expansion mindsets 136 may include a readiness mindset, wherein the readiness mindset is a set of attitudes related to a user's available funds for unexpected expenses. In a non-limiting example, a plurality of expansion mindsets 136 may include a foundation mindset, wherein the foundation mindset is a set of attitudes related to financial protections for protecting a user and the user's family. Protections may include a will and/or trust, savings, assets that can be liquidated, life insurance, disability insurance, long-term care insurance, and the like. In a non-limiting example, a plurality of expansion mindsets 136 may include a resource mindset, wherein the resource mindset is a set of attitudes related to a user's proactive tracking of expenses. In a non-limiting example, a plurality of expansion mindsets 136 may include a wellness mindset, wherein the wellness mindset is a set of attitudes related to a user's prioritization of health and fitness. In a non-limiting example, a plurality of expansion mindsets 136 may include a caring mindset, wherein the caring mindset is a set of attitudes related to steps taken by user to ensure that persons close to user, such as the user's family, can access documents and accounts related to the user. In a non-limiting example, a plurality of expansion mindsets 136 may include an accumulation mindset, wherein the accumulation mindset is a set of attitudes related to a user's plan for saving money to achieve one or more life goals. In a non-limiting example, a plurality of expansion mindsets 136 may include a walkaway mindset, wherein the walkaway mindset is a set of attitudes related to a user's enrollment in at least a retirement account. In a non-limiting example, plurality of expansion mindsets 136 may include a partnership mindset, wherein the partnership mindset is a set of attitudes related to a user's willingness to work with a financial advisor in partnership.

With continued reference to FIGS. 1A-B, processor 104 is further configured to determine a walkaway plan 140 as a function of user profile 112. As used in this disclosure, a “walkaway plan” is an evaluation of a user's walkaway within user profile 112. In a non-limiting example, determining a walkaway plan 140 may include determining walkaway plan 140, in a manner similar to determining expansion plan 132. Walkaway plan 140 may be determined based on answers to questions regarding a user's walkaway within viability assessment 116. In some embodiments, a walkaway plan 140 may include a plurality of walkaway mindsets 144 associated with a plurality of state scores 148. As used in this disclosure, a “walkaway mindset” is a set of attitudes for improving a user's walkaway, as described above. Improving a user's walkaway includes increasing the user's joy and quality of life after retirement, helping the user to accomplish their life goals, and the like. In a non-limiting example, a plurality of walkaway mindsets 144 may include a longevity mindset, wherein the longevity mindset is a set of attitudes related to a user's plan for receiving care once the user is no longer able to care for themselves. In a non-limiting example, a plurality of walkaway mindsets 144 may include an income mindset, wherein the income mindset is a set of attitudes related to a user's planning for income after walking away from their current career/employment. In a non-limiting example, a plurality of walkaway mindsets 144 may include a purpose mindset, wherein the purpose mindset is a set of attitudes related to a user's long-term purpose, or “next chapter,” after walking away from their current career/employment. Additionally, or alternatively, a plurality of walkaway mindsets 144 may include one or more shared mindsets from a plurality of expansion mindsets 136, wherein each shared mindset may be a set of attitudes that are common to both a user's expansion and the user's walkaway. In a non-limiting example, a plurality of expansion mindsets 136, such as, without limitation, readiness mindset, wellness mindset, foundation mindset, caring mindset, and partnership mindset—may be shared with walkaway mindsets 144.

With continued reference to FIGS. 1A-B, in some embodiments, processor 104 may represent each alternative future state as a persistent, fixed-dimensional state vector including a plurality of normalized parameters corresponding to machine-defined state variables. For example, and without limitation, an expansion plan 132 may be represented as an expansion state vector, and a walkaway plan 140 may be represented as a walkaway state vector, enabling alternative future conditions to be evaluated using machine-level operations. In some embodiments, an expansion mindset 136 may correspond to one or more subsets or dimensions of the expansion state vector, and a walkaway mindset 144 may correspond to one or more subsets or dimensions of the walkaway state vector, such that qualitative or behavioral attributes associated with each mindset are encoded as normalized values for computational processing. The parameters of each state vector may be selected and normalized such that the vector occupies a bounded representation independent of the size, format, or heterogeneity of underlying input data. For the purposes of this disclosure, an “expansion state vector” is a machine-readable data structure that encodes parameters corresponding to an expansion plan. For the purposes of this disclosure, a “walkaway state vector” is a machine-readable data structure that encodes parameters corresponding to a walkaway plan. For the purposes of this disclosure, a “dimension” of a state vector is a predefined position within the vector that corresponds to a machine-defined state variable and stores a normalized value derived from one or more items of input data. As a non-limiting example, dimensions of an expansion state vector or a walkaway state vector may correspond to financial attributes, behavioral attributes, temporal attributes, constraints, or other factors associated with the respective plan or mindset.

With continued reference to FIGS. 1A-B, processor 104 is configured to generate, for each of the plurality of system stages, a state representation 150 including a fixed-dimensional state vector, wherein the fixed-dimensional state vector includes a plurality of normalized parameters corresponding to a plurality of machine-defined state variables. For purposes of this disclosure, a “state representation” is a machine-readable data structure that encodes information associated with a corresponding system stage in a form suitable for computational evaluation, comparison, and/or storage. In embodiments, the state representation may enable the computing system to evaluate relationships among multiple system stages using machine-level operations without reliance on human interpretation. For purposes of this disclosure, a “fixed-dimensional state vector” is a data structure with a predetermined number of parameter positions. In some cases, each position may correspond to a respective machine-defined state variable and remain consistent across different system stages. The fixed dimensionality of the state vector may enable processor 104 to perform efficient comparison, distance computation, and model evaluation across multiple system stages without dynamically altering the structure of the vector. For purposes of this disclosure, “machine-defined state variables” are variables representing aspects of system state, user-related information, or evaluation criteria relevant to system operation. For purposes of this disclosure, “normalized parameters” are numerical values generated by transforming input data associated with a system stage into a standardized numerical form constrained within one or more predefined ranges. Normalization may be performed using one or more scaling, weighting, encoding, or discretization operations, such that variations in scale, format, or magnitude of the underlying input data do not affect comparability across state vectors. In embodiments, processor 104 may assign each normalized parameter to a predetermined position within the fixed-dimensional state vector corresponding to a respective machine-defined state variable. Processor 104 may identify, for a given system stage, a set of input data elements relevant to the machine-defined state variables and may apply one or more transformation operations to derive corresponding parameter values. In embodiments, processor 104 may normalize the derived parameter values by applying one or more normalization functions that constrain the parameter values within predefined numerical ranges, thereby producing the plurality of normalized parameters. Each normalized parameter may then be assigned by processor 104 to a predetermined position within the fixed-dimensional state vector corresponding to a respective machine-defined state variable. In embodiments, processor 104 generates the fixed-dimensional state vector by populating each parameter position with a normalized parameter value or, when input data corresponding to a machine-defined state variable is unavailable, by assigning a default or null value. This approach enables processor 104 to generate state representations having a consistent dimensional structure across different system stages, independent of variations in available input data. The processor 104 may generate and store state representations 150 for multiple system stages concurrently, thereby enabling repeated comparison, evaluation, and analysis of the plurality of system stages without regenerating unchanged state representations.

With continued reference to FIGS. 1A-B, in embodiments, processor 104 may store the fixed-dimensional state vector generated for a respective system stage in memory 108 as an internal data structure. For purposes of this disclosure, an “internal data structure” is a machine-readable data construct stored in memory and used by processor 104 during execution of the computing system. An internal data structure may be generated, maintained, and accessed by the computing system as part of system execution and may not be required to correspond directly to any user-visible representation. In embodiments, internal data structures may include vectors, graphs, tables, arrays, or other data constructs used by processor 104 to represent system stages, state representations, scores, distances, or control information. Once stored, the fixed-dimensional state vector may be maintained by processor 104 for subsequent use without requiring regeneration when additional system stages are evaluated or when repeated comparisons are performed. In embodiments, maintaining the fixed-dimensional state vector may include retaining the normalized parameters corresponding to the machine-defined state variables in memory 108 and reusing the stored state vector for repeated comparison, evaluation, or distance computation across system stages. This persistence may enable processor 104 to perform state score determination and state distance computation without reprocessing the underlying input data or reconstructing the state representation for unchanged system stages. In embodiments, storing and maintaining the fixed-dimensional state vector as an internal data structure reduces computational overhead, minimizes redundant processing operations, and improves efficiency of the computing system. By preserving previously generated state representations, processor 104 enables consistent evaluation of system stages over time and supports concurrent analysis of multiple system stages within a single execution context.

With continued reference to FIGS. 1A-B, in some embodiments, processor 104 may select parameters for inclusion in a state vector by mapping heterogeneous input data 110 into a predefined set of machine-defined state variables. In some cases, input data 110 may include viability assessment 116, user profile 112, and the like. In some cases, input data 110 may include a user profile 112 associated with information corresponding to the now stage 120. As a non-limiting example, the input data 110 may include structured data such as numerical values, categorical indicators, thresholds, or time-series data. As another non-limiting example, the input data 110 may include semi-structured data such as questionnaire responses, survey results, or configuration settings. As another non-limiting example, the input data 110 may include unstructured data such as free-text inputs or qualitative assessments associated with expansion or walkaway mindsets, behavioral data such as interaction patterns or usage signals, temporal data such as timelines or projected milestones, and externally sourced data such as third-party metrics or contextual indicators. As another non-limiting example, the input data 110 may include information from viability assessment 116, user profile 112, and the like. In some embodiments, processor 104 may transform raw input data 110 of varying size, format, or scale into normalized numerical representations using one or more scaling, weighting, discretization, or encoding operations, such that each selected parameter occupies a predetermined dimension of the state vector. In some embodiments, normalization may be performed by applying one or more normalization functions to constrain parameter values within fixed numerical ranges, thereby producing a bounded vector representation independent of the original magnitude, format, or heterogeneity of the underlying input data. The processor 104 may further apply feature selection, dimensionality reduction, or default-value assignment techniques to maintain a fixed number of dimensions for the state vector across different execution contexts. In some cases, state vectors (e.g., expansion state vector, walkaway state vector, and the like) corresponding to different future conditions, including expansion and walkaway state vectors, may be stored concurrently in memory 108 and indexed within a shared coordinate system.

With continued reference to FIGS. 1A-B, processor 104 is configured to determine a state score 148 corresponding to each of the plurality of system stages as a function of the fixed-dimensional state vector associated with each of the plurality of system stages using a state score machine-learning model 156. As used in this disclosure, a “state score” is a quantitative measurement that reflects one or more additional machine-computed characteristics of a corresponding system state. In some cases, state score 148 may reflect a user's status in expansion mindset 136 and/or walkaway mindset 144. In some embodiments, a state score of 148 may be on a scale of x to y, wherein x may represent a minimum state score and y may represent a maximum state score. In a non-limiting example, a low state score may indicate a user has less strength in a given mindset, while a high state score may indicate that a user has greater strength in the given mindset. In some embodiments, state score 148 may be determined as a function of answers to questions within viability assessment 116. In a non-limiting example, viability assessment 116 may include a question related to user's expansion: “how often do you use a cash flow tracker?” Question may include four answers: “never,” “occasionally,” “frequently,” and “at least once a month.” Each answer may be associated with a range of state scores. Answer “never” may associate with a subrange of state scores from x₁ to y₁. Answer “occasionally” may associate with a subrange of state scores from x₂ to y₂. Answer “frequently” may associate with a subrange of state scores from x₃ to y₃. Answer “at least once a month” may associate with a subrange of state scores from x₄ to y₄. In another non-limiting example, viability assessment 116 may include a question related to a user's walkaway: “Do you have a plan in place for care if you are no longer able to care for yourself?” Question may include four response options: “no plan,” “rely on family or friends,” “have some financial provisions for long-term care,” and “have long-term care insurance or sufficient fund.” Each answer may associate with a range of state scores. Answer “no plan” may associate with a subrange of state scores from x₁ to y₁. Answer “rely on family or friends” may associate with a subrange of state scores from x₂ to y₂. Answer “have some financial provisions for long-term care” may associate with a subrange of state scores from x₃ to y₃. Answer “have long-term care insurance or sufficient fund” may associate with a subrange of state scores from x₄ to y₄. Additionally, or alternatively, state score 148 may include a current state score and a target state score. As used in this disclosure, a “current state score” is a state score of expansion mindset 136 or walkaway mindset 144 at now stage 120. As used in this disclosure, a “target state score” is a state score of expansion mindset 136 or walkaway mindset 144 at goal stage 124. In a non-limiting example, current state score may be determined as a function of answer to questions within viability assessment 116 at now stage 120. Target state score may be determined as a function of answer to questions within viability assessment 116 at goal stage 124. Further, state score 148 may include a composite state score, wherein the composite state score is an overall state score representing expansion plan 132 and/or walkaway plan. In a non-limiting example, composite state score may be determined by calculating the sum of a plurality of state scores associated with a plurality of expansion mindsets 136 and/or a plurality of walkaway mindsets 144.

With continued reference to FIGS. 1A-B, in embodiments, processor 104 may be configured to determine a state score 148 corresponding to each of the plurality of system stages by applying a state score machine-learning model 156 to the fixed-dimensional state vector associated with each respective system stage. Processor 104 may provide the normalized parameters of the fixed-dimensional state vector as input to the state score machine-learning model 156, which processes the normalized parameters using one or more learned model parameters to generate a machine-computed output value representing the state score. In embodiments, the state score machine-learning model 156 may evaluate relationships among the normalized parameters within the fixed-dimensional state vector and produces the state score as a quantitative, machine-generated value reflecting a computed characteristic of the corresponding system stage. The state score 148 may represent a relative condition, status, or position of the system stage as determined by the model based on patterns learned during training. In embodiments, processor 104 may determine state scores 148 for multiple system stages by separately evaluating the fixed-dimensional state vector associated with each system stage using the same state score machine-learning model 156, thereby enabling consistent scoring across the plurality of system stages. The state score machine-learning model 156 may be configured to evaluate additional system stages without retraining when new state representations are generated. In embodiments, the state scores 148 generated for the plurality of system stages may be stored in memory 108 and used by processor 104 for subsequent operations, including comparison of system stages, computation of state distance, generation of viability graphs, triggering of additional machine-learning models, and control of configuration of the visual interface 114.

With continued reference to FIGS. 1A-B, in some cases, determining the state score 148 may include training the state score machine-learning model 156 using an initial training set derived from state representations associated with the plurality of system stages, identifying, after the initial training, state representations that are incorrectly scored by the state score machine-learning model, generating an updated training set that includes the initially used training set and the incorrectly scored state representations and retraining the state score machine-learning model 156 using the updated training set. In embodiments, processor 104 may determine the state score 148 by training and retraining the state score machine-learning model 156 using multiple training stages. For purposes of this disclosure, an “initial training set” is a collection of training data used to establish initial model parameters of the state score machine-learning model 156. The initial training set may be generated by processor 104 using previously generated fixed-dimensional state vectors and corresponding reference scoring data and may be used to train the model to produce state scores from state representations. After training using the initial training set, processor 104 may evaluate outputs of the state score machine-learning model 156 to identify state representations that are incorrectly scored, misclassified, or otherwise evaluated with insufficient accuracy. For purposes of this disclosure, an “updated training set” is a collection of training data that includes the initial training set together with additional training data corresponding to the incorrectly scored state representations identified after the initial training. In embodiments, processor 104 may retrain the state score machine-learning model 156 using the updated training set to adjust model parameters in a manner that improves accuracy of state score determination while preserving previously learned relationships captured during the initial training. This iterative training process enables the state score machine-learning model 156 to improve robustness and scoring performance over time without requiring regeneration of state representations or retraining from scratch. In embodiments, processor 104 may identify state representations that are incorrectly scored by the state score machine-learning model 156 by comparing model-generated state scores to one or more reference scoring values associated with the corresponding state representations. The reference scoring values may be obtained from stored labeled training data, previously validated state scores, rule-based scoring functions, threshold-based evaluations, or consensus outputs generated by one or more additional scoring routines. In embodiments, processor 104 may execute a validation operation in which the state score machine-learning model 156 is applied to a set of state representations and the resulting predicted state scores may be evaluated using one or more error metrics, including absolute error, squared error, rank-order error, classification loss, or threshold violation. A state representation may be identified as incorrectly scored when an error metric exceeds a machine-defined threshold, when a predicted state score violates one or more scoring constraints, or when the predicted state score produces an incorrect ordering of system stages relative to the reference scoring values. In embodiments, processor 104 may further identify incorrectly scored state representations by detecting inconsistent scoring behavior across repeated executions or across related system stages, including identifying state scores that fluctuate beyond a stability threshold when corresponding changes in input data remain below a change threshold. In embodiments, processor 104 may store identifiers of the incorrectly scored state representations and may use the identified state representations to generate the updated training set for retraining the state score machine-learning model 156.

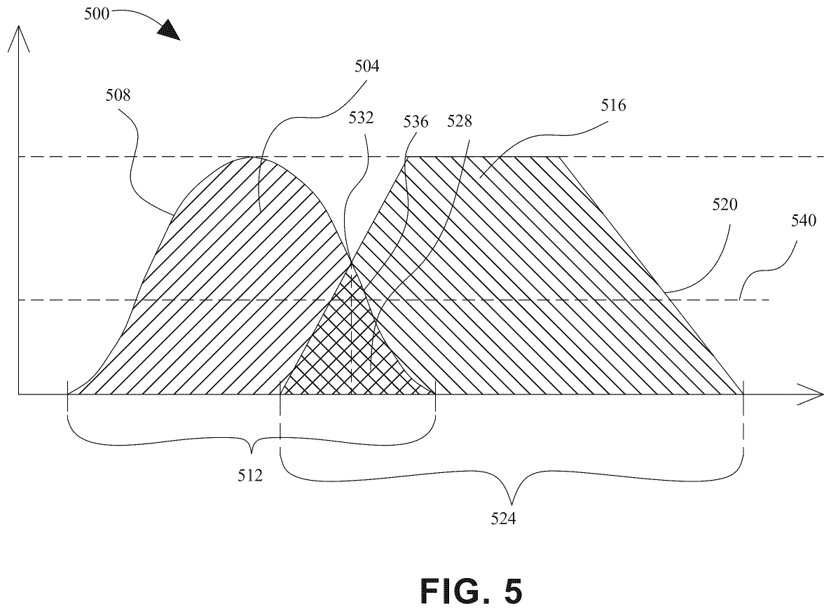

With continued reference to FIGS. 1A-B, in some embodiments, state score 148 may be determined using fuzzy logic. A machine-learning model, such as state score machine-learning model 156 described in further detail below, may be implemented as a fuzzy inferencing system. described in more detail with reference to FIG. 5. As used in the current disclosure, a “fuzzy inference” is a method that interprets the values in the input vector (e.g., a user profile) and, based upon a set of rules, assigns the values to the output vector. A fuzzy set may also be used to show a degree of match between fuzzy sets may be used to rank one resource against another. For instance, if both user profile 112 and state score 148 have fuzzy sets, state score 148 may be determined by having a degree of overlap exceeding a predetermined threshold.

With continued reference to FIGS. 1A-B, in some embodiments, processor 104 may determine state score 148 using a using a lookup table. A “lookup table,” for the purposes of this disclosure, is an array of data that maps input values to output values. A lookup table may be used to replace a runtime computation with an array indexing operation. In another non-limiting example, a state score lookup table may be able to correlate user profile 112 such as, without limitation, user-related data and the like to one or more state scores 148. Processor 104 may be configured to “lookup” one or more user profiles 112 in order to find a corresponding state score 148. In other examples, a state score lookup table may be able to correlate viability assessment 116, in particular, an answer to a question within viability assessment 116, to one or more state scores 148. Processor 104 may be configured to lookup one or more answers to find a corresponding state score 148.

With continued reference to FIGS. 1A-B, processor 104 may use a machine-learning module, such as viability module 152, to implement one or more algorithms or generate one or more machine-learning models, such as state score machine-learning model 156, to determine one or more state scores 148. However, the machine-learning module is exemplary and may not be necessary to generate one or more machine-learning models and perform any machine-learning described herein. In one or more embodiments, one or more machine-learning models may be generated, using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories/values of data elements. Exemplary inputs and outputs may come from data store 128, such as any database described in this disclosure, or be provided by a user. In other embodiments, a machine-learning module may obtain a training set by querying a communicatively connected database that includes past inputs and outputs. Training data may include inputs from various types of databases, resources, and/or user inputs and outputs correlated with each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories or values of data elements by, for example, associating the data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. Viability module 152 may be used to generate a state score machine-learning model and/or any other machine-learning model, such as state distance machine-learning model 160, viability coaching plan machine-learning model 164, and the like described below, using training data. State score machine-learning model 156 may be trained by correlated inputs and outputs of training data. Training data may be datasets that have already been converted from raw data whether manually, by machine, or by any other method. Training data may include previous outputs, such that state score machine-learning model 156 iteratively produces outputs. State score machine-learning model 156 may output converted data based on input of training data, using a machine-learning process. In an embodiment, determining expansion plan 132 and/or walkaway plan 140 containing plurality of expansion mindsets 136 and/or plurality of walkaway mindsets 144 may include determining a state score 148 for each expansion mindset and/or walkaway mindset based on user profile 112 using a machine-learning model, such as state score machine-learning model 156 generated by viability module 152. State score machine-learning model 156 may be trained by training data, discussed in further detail below, such as state score training data. State score training data may be stored in data store 128.

With continued reference to FIGS. 1A-B, in some embodiments, training data used to train one or more machine-learning models described herein, including the state score machine-learning model 156 and any secondary machine-learning models, may be obtained from one or more sources accessible to processor 104. Such training data may include state representations generated by the computing system, historical system data stored in memory 108, previously computed state scores, state distances, and outcomes associated with prior system stages. In some embodiments, training data may further be derived from user-provided data, system-generated data, or externally sourced data received via a communication interface, provided that such data is processed by processor 104 to generate machine-defined state variables or normalized parameters suitable for model training. In some embodiments, processor 104 may generate training data during system operation by capturing state representations, model outputs, and validation results produced during execution of the computing system and may store such data in memory 108 for use as initial training data, updated training data, or both. Accordingly, training data for the machine-learning models may be sourced from a combination of internally generated system data, previously stored data, and data received from external sources, without requiring manual labeling or user intervention.

With continued reference to FIGS. 1A-B, determining state score 148 on each expansion mindset and/or walkaway mindset, based on a user profile using a machine-learning model, may include receiving state score training data. In an embodiment, state score training data may include a plurality of user profiles 112 that are each correlated with a plurality of state scores 148. For example, state score training data may be used to show that user profiles may indicate a particular strength on plurality of expansion mindsets 136 and/or walkaway mindsets 144. Determining state score 148, using a machine-learning model, may further include training a state score machine-learning model 156 as a function of state score training data. Further, determining state score 148 using a machine-learning model may also include determining one or more state scores 148, using trained state score machine-learning model 156.

With continued reference to FIGS. 1A-B, processor 104 is further configured to generate a viability coaching plan 168 as a function of expansion plan 132 and walkaway plan 140. As used in this disclosure, a “viability coaching plan” is a strategy that guides a user toward success in an expansion mindset and/or walkaway mindset. As used in this disclosure, an “expansion mindset” is an attitude affecting a user's expansion, as described above. As used in this disclosure, a “walkaway mindset” is an attitude toward affecting a user's walkaway, as described above. In a non-limiting example, viability coaching plan 168 may only include goals and/or corresponding strategies in an expansion mindset. In another non-limiting example, viability coaching plan 168 may only include goals and/or corresponding strategies in a walkaway mindset. In a further non-limiting example, viability coaching plan 168 may include combining a plurality of viability coaching plans; for instance, and without limitation, viability coaching plan 168 may combine a first viability coaching plan that focuses on an expansion mindset with a second viability coaching plan that focuses on the walkaway mindset described above. In this case, viability coaching plan 168 may include goals and/or corresponding strategies in an expansion mindset and walkaway mindset. In some embodiments, generating a viability coaching plan may include providing a visual interface 114 configured to display viability coaching plan 168. As used in this disclosure, a “visual interface” is a form of interface that is visible to a user and allows users to interact with apparatus 100. In a non-limiting example, viability coaching plan 168 may be present graphically through a graphical user interface (GUI). In some embodiments, the visual interface 114 may be configured to present user profile 112, viability assessment 116, expansion plan 132, walkaway plan 140, and the like. In a non-limiting example, a visual interface 114 may be a web page displaying questions and corresponding response options of viability assessment 116. Processor 104 may receive user profile 112 while user interacts with visual interface 114.

With continued reference to FIGS. 1A-B, in some embodiments, viability coaching plan may include a viability graph 176. Viability graph 176 may be displayed through visual interface 114. As used in this disclosure, a “viability graph” is a diagram displaying one or more state scores 148 from expansion plan 132 and/or walkaway plan 140, within a viability coaching plan. In a non-limiting example, viability graph 176 may express a relationship between expansion plan 132, particularly a plurality of expansion mindsets 136 and plurality of state scores 148. In another non-limiting example, viability graph 176 may express a relationship between walkaway plan 140, a particularly plurality of walkaway mindsets 144 and a plurality of state scores 148. In some embodiments, viability graph 176 may include a line graph, wherein the line graph is a plot showing how information changes from one point to another, using a plurality of lines, wherein the point is an intersection of a first variable from a first entity and a second variable from a second entity. In some embodiments, without limitation, viability graph 176 may be expressed in a two-dimensional (2D) space, wherein the two-dimensional space may consist of a horizontal axis (x-axis) and a vertical axis (y-axis). In a non-limiting example, viability coaching plan may be visualized through a line graph in two-dimensional space, wherein vertical axis may represent a plurality of state scores 148 and horizontal axis may represent a plurality of expansion mindsets 136 and/or a plurality of walkaway mindsets 144. In other embodiments, without limitation, viability graph 176 may be expressed in a multi-dimensional space, wherein the multi-dimensional space may consist of a plurality of axes. Each axis or plurality of axes may represent a single mindset within a plurality of expansion mindsets 136 and/or plurality of walkaway mindsets 144, such as, without limitation, a readiness mindset, foundation mindset, resource mindset, wellness mindset, caring mindset, accumulation mindset, walkaway mindset, partnership mindset, longevity mindset, income mindset, purpose mindset, and the like. Additionally, or alternatively, viability graph 176 may include a plurality of line graphs, wherein each line graph of plurality of line graph may represent a relationship between two entities at a single stage. In a non-limiting example, viability graph 176 may include a first line graph representing a relationship between plurality of expansion mindsets 136/plurality of walkaway mindsets 144 and corresponding plurality of state scores 148 at now stage 120. A viability graph may further include a second line graph representing a relationship between a plurality of expansion mindsets 136, a plurality of walkaway mindsets 144, and a corresponding plurality of state scores 148 at goal stage 124. Further, viability graph 176 may include a plurality of viability graphs. In a non-limiting example, viability graph 176 may include a first viability graph for expansion plan 132 and a second viability graph for walkaway plan 140.

With continued reference to FIGS. 1A-B, processor 104 is configured to determine a state distance 172 between at least two system stages based on a comparison of the state scores 148 of the plurality of system stages. In some embodiments, generating viability coaching plan 168 may include identifying a state distance 172 as a function of expansion plan 132 or walkaway plan 140. As used in this disclosure, a “state distance” is a distance between two state scores. State score may include any state score described in this disclosure. In some embodiments, state distance 172 may include distance between state score 148 at different stages. Stage may include any stage described above in this disclosure. In a non-limiting example, state distance 172 may include a distance between state score 148 from now stage 120 to goal stage 124; for instance, identifying the state distance 172 may include comparing a current state score with a target state score. Continuing the example, state distance 172 between current state score x and target state score y may be y−x. In another non-limiting example, expansion plan 132 and/or walkaway plan 140 may include a first state vector determined at now stage 120 and a second state vector determined at goal stage 124, wherein the first state vector and the second state vector are a plurality of state scores in vector data structure described above. Each state score 148 may be correlated with one of a plurality of expansion mindsets 136. Processor 104 may identify state distance 172 by calculating a vector distance as a function of first state vector and a second state vector. In other non-limiting example, identifying a state distance 172 may include identifying a distance between two lines in viability graph 176; for instance, a distance between one or more data points on a first line graph and one or more data points on a second line graph. In other embodiments, processor 104 may be configured to identify state distance 172 as a function of expansion plan 132 and walkaway plan 140, using a machine-learning model, such as state distance machine-learning model 160 generated by viability module 152. State distance machine-learning model 160 may be trained by training data, discussed in further detail below, such as state distance training data. State distance training data may be stored in data store 128, such as a database as described above.

With continued reference to FIGS. 1A-B, identifying state distance 172 as a function of expansion plan 132 and walkaway plan 140, using a machine-learning model, may include receiving state distance training data. In an embodiment, state distance training data may include a plurality of state score pairs that are each correlated to one of a plurality of state distance. As used in this disclosure, a “state score pair” is a set of state scores 148, wherein the set contains one or more state scores from one stage such as, without limitation, now stage 120, and one or more state scores from another stage such as, without limitation, goal stage 124. In a non-limiting example, state score pair may include a current state score paired with a target state score. For example, state distance training data may be used to show a plurality of state scores 148 and may indicate a particular state distance in between plurality of stages. In an exemplary embodiment, stage may be now stage 120, goal stage 124, and the like. Identifying state distance 172, using a machine-learning model, may further include training state distance machine-learning model 160 as a function of state distance training data. Further, identifying state distance 172, using a machine-learning model, may also include identifying state distance 172, using trained state distance machine-learning model 160.

With continued reference to FIGS. 1A-B, state distance machine-learning model 160 may be trained to compute similarity or divergence metrics between normalized state vectors using pre-optimized parameters. In some embodiments, such similarity or divergence metrics may be used to generate one or more distance-based outputs, including state scores 148, that reflects machine-computed relationships between alternative future state vectors. Unlike conventional machine-learning systems that require retraining when new comparative states are introduced, the disclosed model operates on normalized vector inputs such that additional state vectors may be evaluated without modification to underlying model weights. In some embodiments, the model constrains parameter updates to incremental adjustments derived from newly received data, thereby reducing output variance across successive executions and improving inference stability. This configuration reduces computational load, minimizes memory usage, and preserves previously learned state relationships. These improvements arise from the internal operation of the machine-learning model itself, rather than from the semantic content of any output provided to a user. In contrast to conventional systems that overwrite or degrade prior learned representations when new data is introduced, the disclosed system incrementally updates selected dimensions of existing state vectors while preserving previously stored vectors and relationships. This approach mitigates catastrophic overwrite of learned parameters and enables newly received data to be evaluated in the context of previously computed states. As a result, the system improves efficiency and reliability while avoiding repeated recomputation or retraining. In some embodiments, outputs generated by the state distance machine-learning model 160, including state scores 148 derived from distance computations, are not limited to human-readable information. Instead, such outputs function as machine-generated control structures that govern downstream system behavior. For example, model outputs may control allocation of computational resources, selection of subsequent inference paths, prioritization of processing tasks, or configuration of system output behavior. As such, the outputs directly affect operation of the computing system rather than merely presenting advice or recommendations to a user.

With continued reference to FIGS. 1A-B, in embodiments, processor 104 may determine the state distance 172 by performing one or more machine-executed comparison operations on the state scores 148 corresponding to at least two system stages. For example, and without limitation, processor 104 may retrieve a first state score associated with the now stage and a second state score associated with a goal stage from memory 108 and may compute the state distance 172 as a function of a difference, ratio, weighted difference, or other similarity or divergence measure derived from the first and second state scores. In embodiments, processor 104 may determine state distance 172 for a plurality of goal stages by computing a respective state distance between the state score associated with the now stage and each state score associated with a corresponding goal stage, thereby enabling multi-stage evaluation within a single execution context. In some embodiments, processor 104 may apply one or more normalization or scaling operations to the state scores prior to comparison to support consistent state distance determination across system stages. In embodiments, processor 104 may store the computed state distance 172 in memory 108 and use the state distance 172 as an input to downstream system operations, including controlling configuration of the visual interface, determining ordering or grouping of stage-related information, triggering additional processing routines, generating a viability graph, or triggering execution of a secondary machine-learning model. The determination of state distance 172 may be performed by processor 104 as part of system execution and does not require manual calculation or user interpretation.

With continued reference to FIGS. 1A-B, processor 104 is configured to control at least a system operation 178 as a function of the state distance 172, wherein the at least a system operation 178 includes controlling configuration of a visual interface 114. For purposes of this disclosure, a “system operation” is an operation executed by the computing system that affects system behavior, processing flow, resource usage, or output generation. In some cases, system operation 178 may include execution of processing routines, triggering of machine-learning models, generation or update of internal data structures, transmission of system-generated notifications, or configuration of interface behavior. For purposes of this disclosure, “configuration of a visual interface” refers to machine-controlled arrangement, presentation, or rendering behavior of interface elements displayed on a display device. In some cases, configuration of a visual interface may include layout, ordering, grouping, emphasis, visibility, formatting, or availability of visual elements. Configuration of the visual interface may be modified dynamically by processor 104 without requiring explicit user input. In embodiments, processor 104 may control the at least a system operation 178 by evaluating the state distance 172 against one or more machine-defined control conditions. Based on the evaluated state distance, processor 104 may select, enable, disable, or modify execution of one or more system operations. In embodiments, controlling configuration of the visual interface 114 may include generating interface control data derived from the state distance 172 and applying the interface control data to determine how information associated with the plurality of system stages is rendered within the visual interface 114. For example, processor 104 may modify ordering, grouping, emphasis, or visibility of visual elements associated with the plurality of system stages based on relative magnitudes of the state distance. In embodiments, processor 104 may automatically update the configuration of the visual interface 114 as the state distance 172 changes over time, thereby enabling the visual interface to reflect machine-computed relationships among system stages without requiring manual navigation or interpretation by a user. Control of system operation and visual interface configuration may be performed by processor 104 as part of system execution and may be independent of the semantic content of any information presented.

With continued reference to FIGS. 1A-B, in some embodiments, viability coaching plan 168 may include a viability coaching step 180. As used in this disclosure, a “viability coaching step” is a recommendation, suggestion, or otherwise advice for enhancing a plurality of expansion mindsets 136 within expansion plan 132 and/or a plurality of walkaway mindsets 144 within walkaway plan 140. In some embodiments, viability coaching step 180 may include recommendations related to reducing state distance 172 for each expansion mindset 136 and/or walkaway mindset 144, described above. In some cases, recommendations within viability coaching step 180 may be different based on state distance 172. In a non-limiting example, expansion plan 132 of a user may include a high state distance in accumulation mindset, viability coaching plan 168, generated based on expansion plan 132, and may include viability coaching step 180, containing a recommendation for the user such as, without limitation: “gaining additional clarity on what you want to achieve and why you want to achieve it can prove motivating. Don't forget the ‘why,’ because when you begin to veer off track (which you probably will), the ‘why’ pulls you back to center—to what you really want.” In some embodiments, viability coaching step 180 may include recommendations related to current state score (i.e., state scores at now stage 120). Continuing the example, viability coaching step 180 may contain another recommendation for the user such as, without limitation: “You've made a great start in this mindset. To move closer to your goal, start by estimating as precisely as possible how much money you need for your goal and documenting how much you have already saved toward your goal.” Additionally, or alternatively, viability coaching plan 168 may be color coded. As used in this disclosure, “color coding” means marking objects with different colors as a means of identification. In some cases, objects may include, without limitation, viability coaching step 180, state distance 172, state score 148, expansion plan 132, plurality of expansion mindsets 136, walkaway plan 140, plurality of walkaway mindsets 144, and the like. In a non-limiting example, expansion mindset/walkaway mindset with a high state distance may be in color red. Expansion mindset/walkaway mindset with a medium state distance may be in color yellow. Expansion mindset/walkaway mindset with a low state distance may be in color green.

With continued reference to FIGS. 1A-B, in some embodiments, generating viability coaching plan 168 may include classifying expansion plan 132 and walkaway plan 140 to at least one viability coaching plan 168 for the user, using a machine-learning model, such as viability coaching plan machine-learning model 164 generated by viability module 152. viability coaching plan machine-learning model 164 may be trained by viability coaching plan training data, wherein the viability coaching plan training data may include a plurality of expansion plan 132 and walkaway plan as input correlated to a plurality of viability coaching plans as output. Dual-goal viability coaching plan viability coaching plan training data may be stored in data store 128, such as a database described above. For example, viability coaching plan training data may be used to show both expansion plan 132 and walkaway plan may indicate a particular viability coaching plan 168 for enhancing both plans. viability coaching plan may be any viability coaching plan described in this disclosure. Generating viability coaching plan 168 using a machine-learning model may further include training the viability coaching plan machine-learning model 164, as a function of viability coaching plan training data. Further, generating viability coaching plan 168, using a machine-learning model, may also include generating at least one viability coaching plan 168 using trained viability coaching plan machine-learning model 164.

With continued reference to FIGS. 1A-B, additionally, or alternatively, viability coaching plan machine-learning model 164 may include a classifier. A “classifier,” as used in this disclosure, is a machine-learning model, such as a mathematical model, neural net, or program, generated by a machine-learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies data that are clustered together, found to be close under a distance metric as described below, or the like. Processor 104 and/or another device may generate a classifier, using a classification algorithm, defined as a process whereby a processor 104 derives a classifier from training data, such as viability coaching plan training data. Classification may be performed using, without limitation, linear classifiers such as without limitation logistic regression and/or naïve Bayes classifiers; nearest neighbor classifiers such as k-nearest neighbors classifiers; support vector machines; least squares support vector machines; fisher's linear discriminant; quadratic classifiers; decision trees; boosted trees; random forest classifiers; learning vector quantization; and/or neural network-based classifiers.

With continued reference to FIGS. 1A-B, processor 104 may be configured to generate a classifier using a K-nearest neighbors (KNN) algorithm. A “K-nearest neighbors algorithm” as used in this disclosure, includes a classification method that utilizes feature similarity to analyze how closely out-of-sample features resemble training data. Classifying input data to one or more clusters and/or categories of features, as represented in training data, may be performed by representing both training data and input data in vector forms and using one or more measures of vector similarity to identify classifications within training data and to determine a classification of input data. A K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. A heuristic may include selecting some number of highest-ranking associations and/or training data elements.

With continued reference to FIGS. 1A-B, generating k-nearest neighbors algorithms may generate a first vector output containing a data entry cluster, generating a second vector output containing an input data, and calculating the distance between the first vector output and the second vector output, using any suitable norm, such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute. Examples are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions, as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute corresponding to index i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIGS. 1A-B, additionally, or alternatively, processor 104 may be further configured to generate a group viability model 184, configured to provide a group insight, wherein the group viability model 184 may include a plurality of viability coaching plans 168. As used in this disclosure, a “group viability model” is an application of viability coaching plan 168 in a group setting. In a non-limiting example, processor 104 may receive a plurality of user profiles 112 from a group, wherein the group may include a plurality of group members. Processor 104 may generate a viability coaching plan 168 for each team member, using any processing step described in this disclosure. As used in this disclosure, a “group insight” is an in-depth understanding of a group. In a non-limiting example, group insight may include the priority of tasks and/or goals of each group member. In some cases, tasks may include, without limitation, viability coaching step 180; for instance, providing group insight may include identifying one or more viability coaching step 180 for greatest state distance 172 within viability coaching plan 168, for each group member. In some embodiments, group viability model may include a comparison of a plurality of viability coaching plans 168. In a non-limiting example, group viability model may include a comparison matrix, wherein the comparison matrix may include a plurality of columns and a plurality of rows. Each column may represent a single expansion mindset or walkaway mindset within expansion plan 132 or walkaway plan 140. Each row may represent one team member. Elements of comparison matrix may include a state score 148. In some cases, each column of comparison matrix may further include a plurality of sub-columns representing a plurality of stages such as, without limitation, now stage 120, goal stage 124, and the like. Group viability model 184 may be used to identify weaknesses (e.g., element of comparison matrix with low state score) and/or strengths (i.e., element of comparison matrix with a high state score) among team members.

With continued reference to FIGS. 1A-B, in some embodiments, the system dynamically controls visual interface behavior based on machine-computed state-distance relationships. Rather than merely displaying multiple outcomes, the system automatically organizes, prioritizes, or groups system-generated states according to machine-determined relevance metrics. The system may dynamically adjust visual interface layout, ordering, emphasis, or visibility of interface elements without requiring user input. This includes generating composite or adaptive visual interface views that integrate multiple alternative states into a single presentation. By automatically controlling visual interface behavior, the system reduces the number of navigation operations required to evaluate alternative states and improves efficiency of the computing device itself. By organizing and prioritizing system-generated states within a unified visual interface, the disclosed system reduces repeated user navigation between screens, views, or filters. Users are not required to manually compare outputs or apply interaction-based operations to understand relationships between alternative states. This reduction in navigation steps minimizes redundant rendering operations, input processing, and execution overhead, thereby improving the operation of the computing device independent of the content of any information presented. Visual interface reconfiguration may be governed by machine-generated control structures derived from state-distance computations. These control structures determine which interface components are rendered, how they are arranged, and how interaction is managed. Accordingly, the visual interface operates as an extension of the computing system's internal control logic rather than as a passive display of information. The concurrent maintenance, normalization, and comparison of multiple high-dimensional state vectors across different temporal horizons requires access to memory-resident data structures, machine-learning inference routines, and automated rendering logic executed by the computing system.

With continued reference to FIGS. 1A-B, in embodiments, processor 104 may control at least one system operation 178 by generating a viability graph 176 as a function of the state distance 172. In embodiments, processor 104 may generate the viability graph 176 by identifying the plurality of system stages for which state scores 148 and state distances 172 have been determined and constructing an internal data structure in which each system stage is represented as a node. For purposes of this disclosure, a “node” is a data element to represent an entity, condition, or state within a graph-based data structure. In some cases, node may be associated with one or more attributes derived from system data, including a state representation, a state score, or other machine-computed values. For purposes of this disclosure, an “edge” is an element of the viability graph that represents a relationship between two or more nodes. In some cases, edge may encode a state distance, similarity measure, or other quantitative relationship computed between the corresponding system stages. Processor 104 may associate each node with the corresponding state score 148 and may generate one or more edges between nodes by computing and assigning edge values based on the state distances 172 between respective system stages. In embodiments, processor 104 may generate the viability graph 176 by iteratively adding nodes and edges to the internal data structure as additional system stages are evaluated or as state scores 148 or state distances 172 are updated. Each edge may encode a relative distance, similarity, or relationship between two system stages based on the state distance 172, and processor 104 may update edge values without regenerating unchanged nodes when only a subset of state distances changes. In embodiments, the viability graph 176 may be stored in memory as a persistent internal data structure and may be used by processor 104 to support subsequent system operations, including determining ordering or grouping of system stages, selecting processing routines, or controlling configuration of the visual interface. In embodiments, processor 104 may display the viability graph 176 within the visual interface by rendering a graphical representation of the nodes and edges on a display device, and the displayed viability graph 176 may visually convey machine-computed relationships among system stages. In embodiments, processor 104 may dynamically update the displayed viability graph 176 as state scores 148 or state distances 172 change over time, without requiring regeneration of the underlying state representations.

With continued reference to FIGS. 1A-B, in embodiments, processor 104 may control at least one system operation by evaluating the state distance 172 against one or more processing conditions 186. For purposes of this disclosure, a “processing condition” is a machine-defined criterion, threshold, rule, or logical condition to determine whether a system operation is to be performed. In embodiments, a processing condition 186 may be defined in terms of a numerical threshold applied to the state distance 172, a range of state distance values, a comparison between multiple state distances associated with different system stages, or a logical combination of such conditions. In embodiments, processor 104 may evaluate the state distance 172 against the one or more processing conditions 186 by retrieving the state distance 172 from memory and applying one or more comparison or decision operations to determine whether the state distance satisfies the processing condition 186. For example, processor 104 may determine whether the state distance 172 exceeds or falls below a predefined threshold, whether the state distance 172 changes by more than a predefined amount over time, or whether the state distance 172 meets a condition relative to another state distance associated with a different system stage. In embodiments, when the state distance 172 satisfies one or more processing conditions 186, processor 104 may trigger execution of a secondary machine-learning model, including state distance machine-learning model 160, viability coaching plan machine-learning model 164, and the like. The secondary machine-learning model may be configured to generate a viability coaching plan data structure as a function of the state score 148 and the state distance 172. In embodiments, the viability coaching plan data structure may be stored in memory 108 and used by processor 104 to control subsequent system processing operations or configuration of the visual interface, without requiring user initiation or manual interpretation.

With continued reference to FIGS. 1A-B, in embodiments, processor 104 may control configuration of the visual interface 114 by dynamically modifying layout, ordering, or visibility of visual elements as a function of the state distance 172. For purposes of this disclosure, a “visual element” is a displayable component of the visual interface. In some cases, visual element may include text, graphics, icons, charts, controls, or other interface components rendered on a display device. In embodiments, processor 104 may modify layout, ordering, or visibility of visual elements by generating interface control data derived from the state distance 172 and applying the interface control data to determine how visual elements are arranged or rendered within the visual interface. For example, processor 104 may determine a relative priority or ranking of system stages based on the state distance 172 and may adjust ordering of corresponding visual elements to reflect the determined priority. In embodiments, processor 104 may modify layout by repositioning visual elements, resizing visual elements, grouping related visual elements, or allocating display space among visual elements based on the state distance 172. In embodiments, processor 104 may modify visibility by selectively displaying, hiding, emphasizing, or de-emphasizing visual elements associated with particular system stages when the state distance 172 satisfies one or more display-related conditions. In embodiments, processor 104 may perform the dynamic modification of visual elements automatically during system execution and without requiring user input, such that the visual interface reflects machine-computed relationships among system stages. The modifications to layout, ordering, or visibility may be updated as the state distance 172 changes over time, thereby enabling the visual interface to adapt dynamically to changes in system state.

With continued reference to FIGS. 1A-B, in embodiments, processor 104 may control configuration of the visual interface 114 by providing a visual summary associated with the plurality of system stages. For purposes of this disclosure, a “visual summary” is a visual presentation that presents selected information associated with multiple system stages in a condensed form. In embodiments, processor 104 may generate the visual summary by retrieving information associated with the plurality of system stages from memory and applying one or more summarization, filtering, or selection operations to determine which information is to be included, such that the visual summary may present selected information without initiating full processing associated with any individual system stage. In embodiments, processor 104 may determine a subset of information as a function of the state distance 172 by evaluating the state distance 172 and selecting information associated with system stages that satisfy one or more selection criteria derived from the state distance. For purposes of this disclosure, a “subset of information” is a machine-selected portion of information associated with one or more system stages and derived from system data. For purposes of this disclosure, “system data” is data maintained, generated, or accessed by the computing system during execution of system operations. In some cases, system data may include data representing system stages, state representations, state scores, state distances, viability graphs, or other internal data structures. In embodiments, processor 104 may selectively present the subset of information within the visual summary by controlling rendering of corresponding visual elements within the visual interface. Processor 104 may further enable interaction with the subset of information by associating the displayed information with one or more interaction handlers such that, upon user interaction with a portion of the visual summary, processor 104 may initiate processing associated with a selected system stage, including generation or retrieval of additional system data, execution of processing routines, or updating of the visual interface. The generation and presentation of the visual summary, determination of the subset of information, and enabling of interaction may be performed automatically by processor 104 during system execution and updated dynamically as the state distance 172 changes.

With continued reference to FIGS. 1A-B, in embodiments, processor 104 may detect a display condition in which information associated with the plurality of system stages is at least partially visually constrained. For purposes of this disclosure, a “display condition” is a condition of the visual interface in which available display space, window configuration, or overlapping interface elements limit visibility of displayed information. In embodiments, processor 104 may detect the display condition by monitoring one or more interface parameters, including display dimensions, window size or position, z-order of interface elements, overlap between rendered visual elements, or changes in display orientation or resolution, and determining whether one or more visual elements associated with the plurality of system stages are partially or fully obscured. In embodiments, upon detecting the display condition, processor 104 may reconfigure presentation of the information to an alternative visual arrangement that maintains visibility. For purposes of this disclosure, an “alternative visual arrangement” is a modified layout, format, or presentation configuration to improve visibility of information under the detected display condition. In embodiments, processor 104 may generate the alternative visual arrangement by repositioning visual elements, resizing visual elements, modifying formatting, collapsing or expanding interface sections, changing ordering or grouping of visual elements, or selectively displaying a subset of information associated with the plurality of system stages. In embodiments, processor 104 may automatically apply the alternative visual arrangement during system execution and may restore a prior visual arrangement when the display condition no longer exists. The detection of the display condition and reconfiguration of the presentation may be performed dynamically by processor 104 without requiring user input, thereby enabling the visual interface to adapt to changes in display constraints while maintaining visibility of information associated with the plurality of system stages.

With continued reference to FIGS. 1A-B, in embodiments, processor 104 may control at least one system operation by detecting that a computing device 188 associated with a user is in an inactive network state. For purposes of this disclosure, a “computing device” is any device capable of executing instructions and communicating over a network. In some cases, computing device 188 may include a user device described in this disclosure. For purposes of this disclosure, an “inactive network state” is a state in which the computing device lacks active network connectivity. In embodiments, processor 104 may detect the inactive network state by monitoring one or more network status indicators associated with the computing device, including connection flags, network interface status signals, heartbeat messages, failed transmission attempts, or operating system network state information, and determining that the computing device is unable to establish or maintain network communication. In embodiments, processor 104 may generate and transmit a system-generated notification using a communication channel as a function of the state distance 172. For purposes of this disclosure, a “communication channel” is a wired or wireless transmission medium used to convey data between computing devices. For the purposes of this disclosure, a “system-generated notification” is a message generated by processor 104 without user initiation. In embodiments, processor 104 may generate the system-generated notification by assembling notification data derived from the state distance 172 and may transmit the notification over the communication channel using one or more messaging, signaling, or data transmission protocols supported by the computing system. In embodiments, processor 104 may monitor the network status of the computing device to detect a transition from the inactive network state to an active network state, wherein, for purposes of this disclosure, an active network state is a state in which the computing device has network connectivity. Upon detecting the transition to the active network state, processor 104 may automatically activate the visual interface 114 by initiating rendering or updating of interface elements to present information associated with the state distance 172 and may enable network access to additional system data. In embodiments, processor 104 may perform the detection of network state transitions, transmission of system-generated notifications, and activation of the visual interface automatically during system execution and without requiring user input.

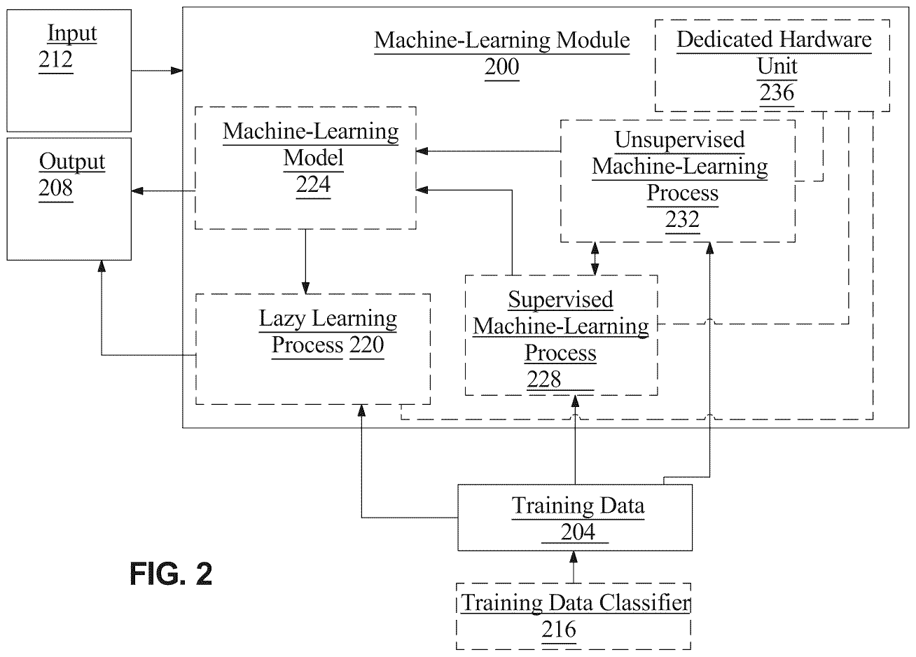

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, input data may include input data, state representation, state score, state distance, and the like. As a non-limiting illustrative example, output data may include state representation, state score, state distance, system operation and the like.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to user cohort related to user demographics, such as age, gender, occupation, communication history, and the like. As a non-limiting example, training data classifier 216 may classify elements of training data to device cohort related to device type, location, and the like.

Still referring to FIG. 2, a computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. A computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 2, a computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 2, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. A computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 2, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 2, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 2, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 2, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include input data, state representation, state score, state distance, and the like as described above as inputs, state representation, state score, state distance, system operation and the like as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Continuing to refer to FIG. 2, evaluation of error function and/or other comparison results may include comparison of each of error function and/or other comparison results to a maximum single error threshold; in other words, a criterion of evaluation may include performing iterative retraining if any single comparison and/or error function output exceeds maximum single error threshold or if a count of single comparison and/or error function outputs exceeding single error threshold exceeds a threshold number and/or proportion of overall error function and/or other comparison results. Alternatively or additionally, evaluation of error function and/or other comparison results may include comparison of an aggregated plurality of error function and/or other comparison results to an aggregate error threshold; in other words, a criterion of evaluation may include performing iterative retraining if a result of averaging or otherwise aggregating a plurality such as some or all evaluated function and/or other comparison results exceeds aggregate error threshold. Aggregation may be performed in any manner of aggregation described in this disclosure and/or any combination thereof. Criteria for evaluations may be evaluated separately such that failing any one criterion causes iterative retraining; alternatively or additionally evaluation results may be combined according to one or more logical or other rules.

As a non-limiting, illustrative example, and still referring to FIG. 2, where outputs to be compared by error function are numerical values, error function may include subtraction of one from the other to derive an absolute value and/or mean squared error. Where outputs and/or training examples are represented as a binary classification, an error function may include a hinge loss function, sigmoid cross entropy loss function, weighted cross entropy loss function, or the like. Where output and/or exemplary output in a training set is a classification to three or more values, error function may include a softmax cross entropy loss function, a sparse cross entropy loss function, a Kullback-Leibler divergence loss function, or the like. Where both retaining and training with include supervised training, retraining may use a different error function, different weight update functions and/or parameters, or the like than in the training stage. For instance, and without limitation, when a previous iterative retraining process included training using examples from until a first convergence threshold and/or epsilon value and/or neighborhood is met, a subsequent iterative retraining process may include a lower convergence threshold, a smaller value of epsilon, or the like. Iterative retraining may include using one or more examples that were not used in any previous training and/or retraining process; for instance, where convergence was initially and/or previously achieved using a first subset of examples a subsequent retraining process may use examples from a second subset of examples, which may be wholly disjoint from first subset and/or have one or more elements that are not found in first subset.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

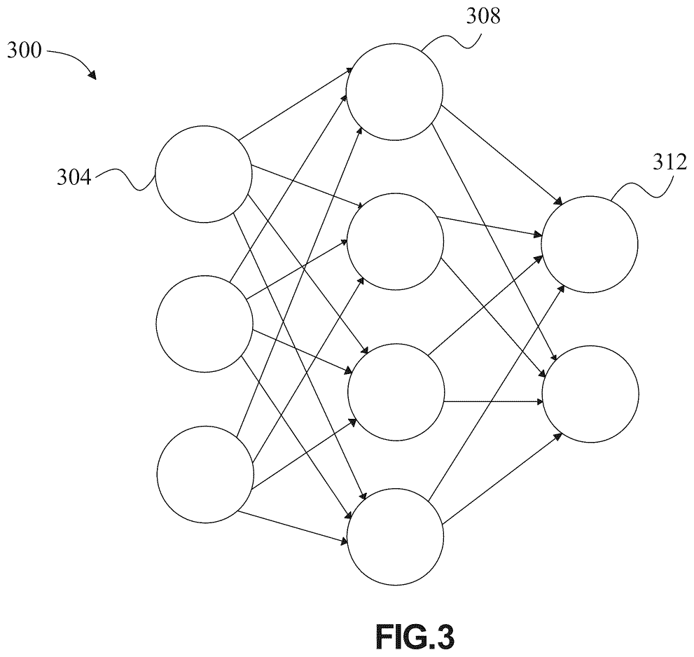

Referring now to FIG. 3, an exemplary embodiment of neural network 300 is illustrated. A neural network 300, also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via a process of “training” the network, in which elements from a training dataset are applied to the input nodes. A suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

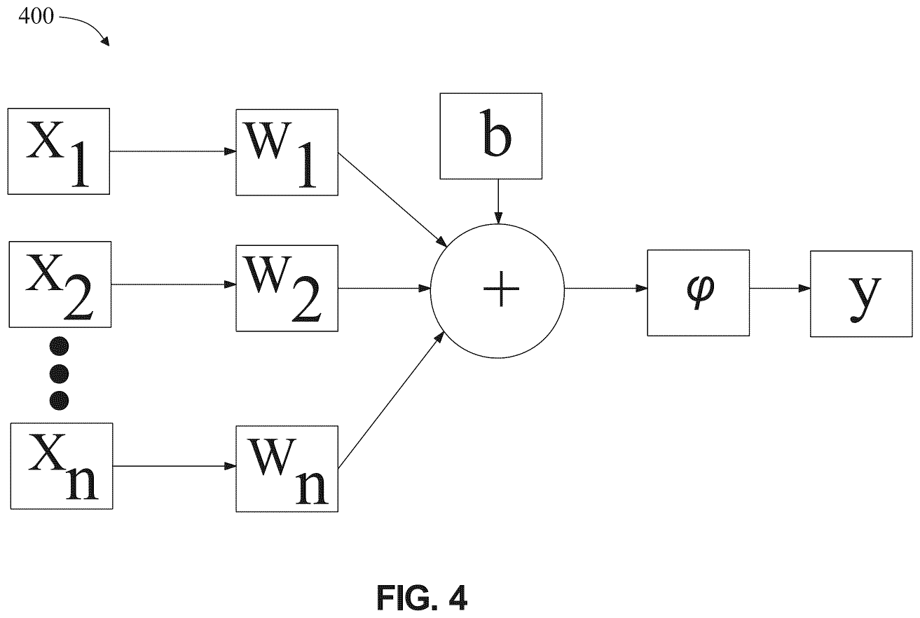

Referring now to FIG. 4, an exemplary embodiment of a node of a neural network 400 is illustrated. A node may include, without limitation a plurality of inputs xᵢ that may receive numerical values from inputs to a neural network containing the node and/or from other nodes. A node may perform a weighted sum of inputs using weights wᵢ that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or an “inhibitory,” indicating it has a weak effect influence on the one more inputs y. For instance by the corresponding weight having a small numerical value. The values of weights wi may be determined by training a neural network using training data, which may be performed using any suitable process as described above.

Referring to FIG. 5, an exemplary embodiment of fuzzy set comparison 500 is illustrated. A first fuzzy set 504 may be represented, without limitation, according to a first membership function 508 representing a probability that an input falling on a first range of values 512 is a member of the first fuzzy set 504, where the first membership function 508 has values on a range of probabilities such as, without limitation, the interval [0,1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements, such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 5, first fuzzy set 504 may represent any value or combination of values as described above, including output from one or more machine-learning models and a predetermined class. A second fuzzy set 516, which may represent any value that may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on a probability interval, of a match between first fuzzy set 504 and second fuzzy set 516. Alternatively, or additionally, a single value of first and/or second fuzzy set may be located at a locus 536 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein, with each other or with either set, which is sufficient for purposes of the matching process. For instance, threshold may indicate a sufficient degree of overlap between an output from one or more machine-learning models and/or user profiles and a predetermined class, such as, without limitation, state score categorization, for combination to occur as described above. Alternatively, or additionally, each threshold may be tuned by a machine-learning and/or statistical process, for instance and without limitation as described in further detail below.

Further referring to FIG. 5, in an embodiment, a degree of match between fuzzy sets may be used to classify a user profile with a state score. For instance, if a state score has a fuzzy set matching a user profile fuzzy set by having a degree of overlap exceeding a threshold, processor 104 may classify the user profile as belonging to the state score categorization. Where multiple fuzzy matches are performed, degrees of match for each respective fuzzy set may be computed and aggregated through, for instance, addition, averaging, or the like, to determine an overall degree of match.

Still referring to FIG. 5, in an embodiment, a user profile may be compared to multiple state score categorization of fuzzy sets. For instance, a user profile may be represented by a fuzzy set that is compared to each of the multiple state score categorization fuzzy sets. A degree of overlap exceeding a threshold between the user profile fuzzy set and any of the multiple state score categorization fuzzy sets may cause processor 104 to classify the user profile as belonging to state score categorization. For instance, in one embodiment, there may be two state score categorization fuzzy sets, representing, respectively, a first state score categorization and a second state score categorization. First state score categorization may have a first fuzzy set; second state score categorization may have a second fuzzy set; a user profile may also have a user profile fuzzy set. Processor 104, for example, may compare a user profile fuzzy set with each of state score categorization fuzzy sets and an instate score categorization fuzzy set, as described above, and classify a user profile to either, both, or neither of state score categorization nor instate score categorization. Machine-learning methods, as described throughout may, in a non-limiting example, generate coefficients used in fuzzy set equations as described above, such as without limitation x, c, and σ of a Gaussian set as described above, as outputs of machine-learning methods. Likewise, a user profile may be used indirectly to determine a fuzzy set. User profile fuzzy set may be derived from outputs of one or more machine-learning models that take the user profile directly or indirectly as inputs.

Still referring to FIG. 5, a computing device may use a logic comparison program, such as, but not limited to, a fuzzy logic model, to determine a state score response. A state score response may include, but is not limited to, a low state score, a medium state score, or a high state score; each such state score response may be represented as a value for a linguistic variable representing a state score response or in other words, a fuzzy set as described above that corresponds to a degree of match of state scores, as calculated using any statistical, machine-learning, or other method that may occur to a person skilled in the art upon reviewing the entirety of this disclosure. In other words, a given element of user profile may have a first non-zero value for membership in a first linguistic variable value such as a first state score and a second non-zero value for membership in a second linguistic variable value such as a second state score. In some embodiments, determining a state score categorization may include using a linear regression model. A linear regression model may include a machine-learning model. A linear regression model may be configured to map data of a user profile, such as degree of match of state scores to one or more state score parameters. A linear regression model may be trained using a machine-learning process. A linear regression model may map statistics such as, but not limited to, quality of a user profile. In some embodiments, determining a state score of a user profile may include using a state score classification model. A state score classification model may be configured to input collected data and cluster data to a centroid based on, but not limited to, frequency of appearance, linguistic indicators of quality, and the like. Centroids may include scores assigned to them, such that quality of each user profile may each be assigned a score. In some embodiments a state score classification model may include a K-means clustering model. In some embodiments, a state score classification model may include a particle swarm optimization model. In some embodiments, determining the state score of a user profile may include using a fuzzy inference engine. A fuzzy inference engine may be configured to map one or more user profile data elements, using fuzzy logic. In some embodiments, a user profile may be arranged by a logic comparison program into state score arrangements. A “state score arrangement,” as used in this disclosure is any grouping of objects and/or data based on skill level and/or output score. This step may be implemented as described above in FIGS. 1-4. Membership function coefficients and/or constants, as described above, may be tuned according to classification and/or clustering algorithms. For instance, and without limitation, a clustering algorithm may determine a Gaussian or other distribution of questions about a centroid corresponding to a given state score level and an iterative or other method may be used to find a membership function for any membership function type as described above that minimizes an average error from the statistically-determined distribution, for instance, example, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 5, an inference engine may be implemented according to input and/or output membership functions and/or linguistic variables. For instance, a first linguistic variable may represent a first measurable value pertaining to a user profile, such as a degree of match of an element, while a second membership function may indicate a degree of in-state score of a subject thereof, or another measurable value pertaining to user profile. Continuing the example, an output linguistic variable may represent, without limitation, a score value. An inference engine may combine rules, such as: “if the amount of user-related data is “high” and the quality of user profile is “high,” the state score is “high.” The degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max (a, b), probabilistic sum of a and b (a+b−a*b), bounded sum, and/or drastic T-conorm; any T-conorm may be used that satisfies the properties of commutativity; ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and an identity element of 0. Alternatively, or additionally T-conorm may be approximated by a sum, as in a “product-sum” inference engine in which T-norm is a product and T-conorm is sum. A final output score or other fuzzy inference output may be determined from an output membership function, as described above using any suitable defuzzification process, including without limitation Mean of Max defuzzification, Centroid of Area/Center of Gravity defuzzification, Center Average defuzzification, Bisector of Area defuzzification, or the like. Alternatively, or additionally, output rules may be replaced with functions according to the Takagi-Sugeno-King (TSK) fuzzy model.

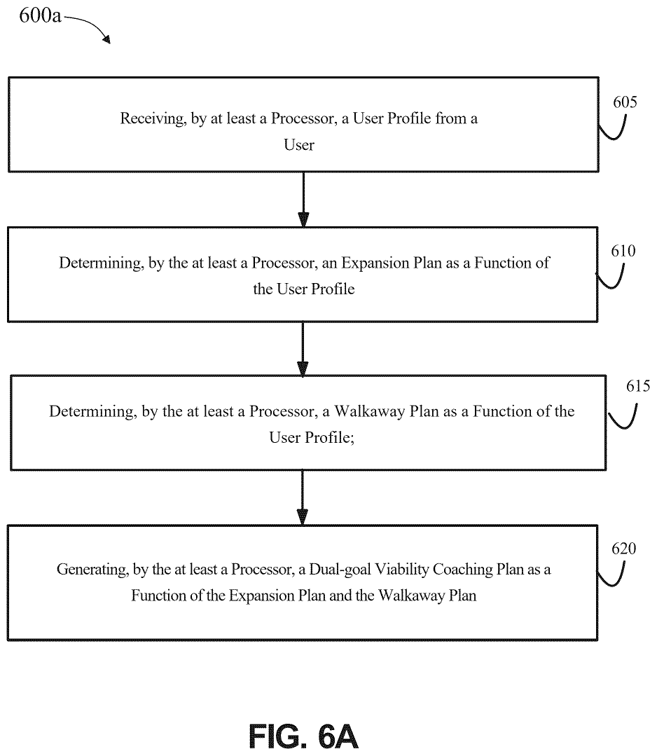

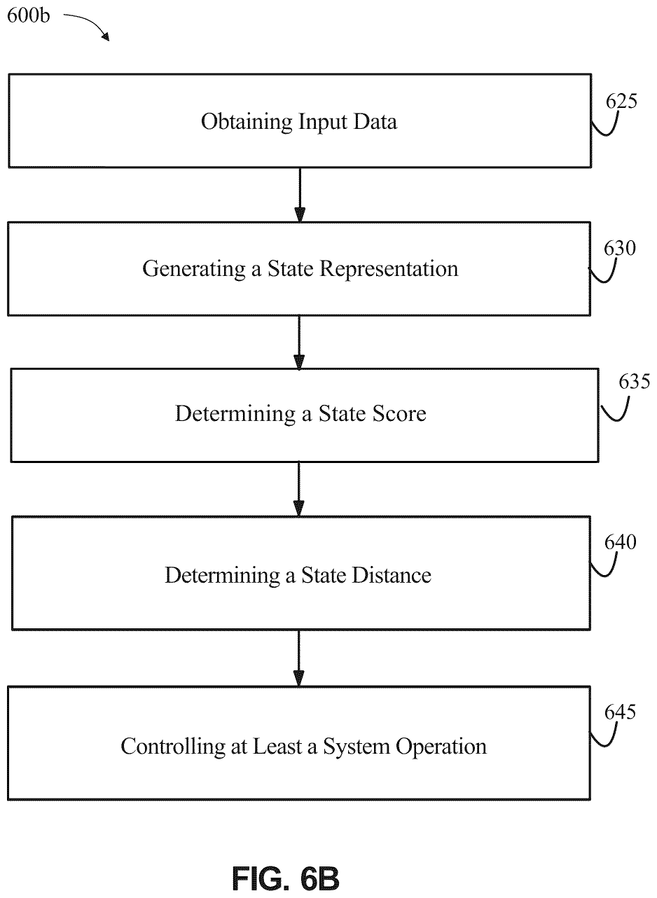

Referring now to FIG. 6A, an exemplary method 600a for generating a viability coaching plan is illustrated. Method 600a includes a step 605 of receiving, by at least a processor and a user profile from a user, without limitation, as described above in reference to FIGS. 1-5. In some embodiments, step 605 of receiving the viability data may include accepting a viability assessment from the user. In some embodiments, a viability assessment may include a plurality of stages, wherein the plurality of stages may include a now stage and a goal stage. This may be implemented, without limitation, as described above in reference to FIGS. 1A-5.

With continued reference to FIG. 6A, method 600a further includes a step 610 of determining, by at least a processor, an expansion plan as a function of the user profile, without limitation, as described above in reference to FIGS. 1-5. In some embodiments, the expansion plan may include a plurality of expansion mindsets associated with a plurality of state scores. This may be implemented, without limitation, as described above in reference to FIGS. 1A-5.

With continued reference to FIG. 6A, method 600a further includes a step 615 of determining, by the at least a processor, a walkaway plan as a function of the user profile, without limitation, as described above in reference to FIGS. 1A-5. In some embodiments, a walkaway plan may include a plurality of walkaway mindsets associated with a plurality of state scores. This may be implemented, without limitation, as described above in reference to FIGS. 1A-5.

With continued reference to FIG. 6A, method 600a further includes a step 620 of generating, by the at least a processor, a viability coaching plan as a function of the expansion plan and the walkaway plan, without limitation, as described above in reference to FIGS. 1A-5. In some embodiments, a viability coaching plan may include a viability coaching step. In some embodiments, a viability coaching plan may include a viability graph. This may be implemented, without limitation, as described above in reference to FIGS. 1A-5. In some embodiments, step 625 of generating a viability coaching plan may include identifying a state distance as a function of the expansion plan and the walkaway plan. In some embodiments, identifying the state distance may include comparing a current state score with a target state score. This may be implemented, without limitation, as described above in reference to FIGS. 1A-5.

With continued reference to FIG. 6A, method 600a may further include a step of generating, by at least a processor, a group viability model, wherein the group viability model comprises a plurality of viability coaching plans. This may be implemented, without limitation, as described above in reference to FIGS. 1A-5.

Referring now to FIG. 6B, a flow diagram of an exemplary method 600b of controlling operation of a computing system is illustrated. Method 600b contains a step 625 of obtaining, using at least a processor, input data associated with a plurality of system stages, wherein the plurality of system stages includes a now stage and at least one goal stage. In some embodiments, the input data may include a user profile associated with information corresponding to the now stage. These may be implemented as described and with reference to FIGS. 1A-6A.

With continued reference to FIG. 6B, method 600b contains a step 630 of generating, using at least a processor and for each of a plurality of system stages, a state representation including a fixed-dimensional state vector, wherein the fixed-dimensional state vector includes a plurality of normalized parameters corresponding to a plurality of machine-defined state variables. In some embodiments, generating the state representation may include storing the fixed-dimensional state vector in the memory as an internal data structure, and maintaining the fixed-dimensional state vector for repeated comparison of system stages without regenerating the state representation. These may be implemented as described and with reference to FIGS. 1A-6A.

With continued reference to FIG. 6B, method 600b contains a step 635 of determining, using at least a processor, a state score corresponding to each of a plurality of system stages as a function of a fixed-dimensional state vector associated with each of the plurality of system stages using a state score machine-learning model. In some embodiments, determining the state score may include training the state score machine-learning model using an initial training set derived from state representations associated with the plurality of system stages, identifying, after the initial training, state representations that are incorrectly scored by the state score machine-learning model, generating an updated training set that may include the initially used training set and the incorrectly scored state representations, and retraining the state score machine-learning model using the updated training set. These may be implemented as described and with reference to FIGS. 1A-6A.

With continued reference to FIG. 6B, method 600b contains a step 640 of determining, using at least a processor, a state distance between at least two system stages based on a comparison of state scores of a plurality of system stages. This may be implemented as described and with reference to FIGS. 1A-6A.

With continued reference to FIG. 6B, method 600b contains a step 645 of controlling, using at least a processor, at least a system operation as a function of a state distance, wherein the at least a system operation includes controlling configuration of a visual interface. In some embodiments, controlling the at least one system operation further may include generating a viability graph as a function of the state distance, wherein the viability graph may include a plurality of nodes corresponding to the plurality of system stages and one or more edges representing the state distance between the plurality of system stages, and displaying the viability graph within the visual interface. In some embodiments, controlling the at least one system operation further may include evaluating the state distance against one or more processing conditions, and in response to the state distance satisfying the one or more processing conditions, triggering execution of a secondary machine-learning model configured to generate a viability coaching plan data structure as a function of the state score and the state distance. In some embodiments, controlling the configuration of the visual interface may include dynamically modifying layout, ordering, and visibility of visual elements within the visual interface as a function of the state distance. In some embodiments, controlling the configuration of the visual interface may include providing a visual summary associated with the plurality of system stages, determining a subset of information as a function of the state distance, selectively presenting, within the visual summary, the subset of information corresponding to the plurality of system stages, and enabling interaction with the subset of information to cause initiation of processing associated with a selected system stage of the plurality of system stages. In some embodiments, controlling the configuration of the visual interface may include detecting a display condition in which information associated with the plurality of system stages is at least partially visually constrained, and reconfiguring presentation of the information associated with the plurality of system stages to an alternative visual arrangement that maintains visibility. In some embodiments, controlling the at least one system operation further may include detecting that a computing device associated with a user is in an inactive network state, generating and transmitting, using a communication channel, a system-generated notification as a function of the state distance, and upon the computing device transitioning to an active network state from the inactive network state, automatically activating the visual interface to present information associated with the state distance and enable network access to additional system data. These may be implemented as described and with reference to FIGS. 1A-6A.

It is to be noted that any one or more of the aspects and embodiments described herein may be conveniently implemented using one or more machines (e.g., one or more computing devices that are utilized as a user computing device for an electronic document or one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instructions, or portions thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

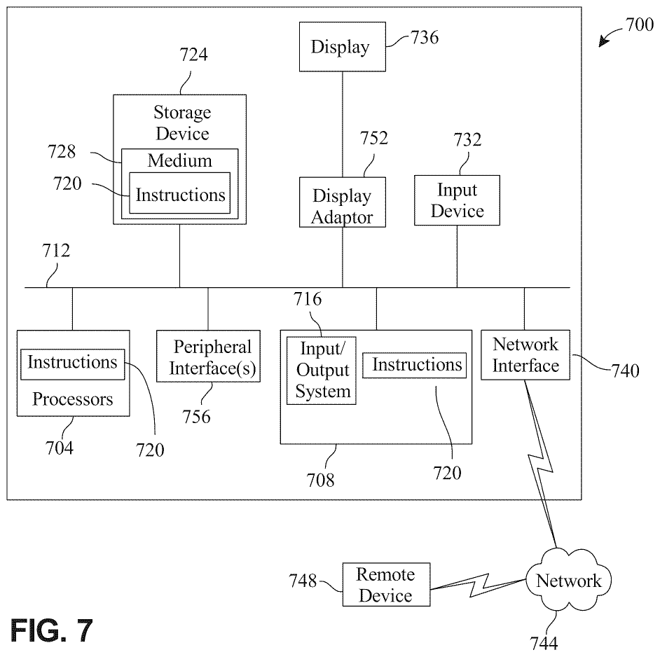

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially-configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors. Processor 704 may be organized according to Von Neumann and/or Harvard architecture, as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), an analog or mixed signal processor, a Trusted Platform Module (TPM), a floating-point unit (FPU), and/or system on a chip (SoC).

Memory 708 may include various components (e.g., machine-readable media) including, but not limited to, a random-access memory component, a read-only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, an advanced technology attachment (ATA), a serial ATA, a universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via an input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor-control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via a storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or another other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display 736. Examples of a display device include, but are not limited to, a liquid crystal display (LCD), a cathode ray tube (CRT), a plasma display, a light-emitting diode (LED) display, and any combinations thereof. Display adapter 752 and display 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An apparatus for controlling operation of a computing system, wherein the apparatus comprises:
at least a processor; and
a memory communicatively connected to the at least a processor, wherein the memory contains instructions configuring the at least a processor to:
obtain input data associated with a plurality of system stages, wherein the plurality of system stages comprises a now stage and at least one goal stage;
generate, for each of the plurality of system stages, a state representation comprising a fixed-dimensional state vector, wherein the fixed-dimensional state vector comprises a plurality of normalized parameters corresponding to a plurality of machine-defined state variables;
determine a state score corresponding to each of the plurality of system stages as a function of the fixed-dimensional state vector associated with each of the plurality of system stages using a state score machine-learning model;
determine a state distance between at least two system stages based on a comparison of the state scores of the plurality of system stages; and
control at least a system operation as a function of the state distance, wherein the at least a system operation comprises controlling configuration of a visual interface.

2. The apparatus of claim 1, wherein the input data comprises a user profile associated with information corresponding to the now stage.

3. The apparatus of claim 1, wherein generating the state representation comprises:
storing the fixed-dimensional state vector in the memory as an internal data structure; and
maintaining the fixed-dimensional state vector for repeated comparison of system stages without regenerating the state representation.

4. The apparatus of claim 1, wherein determining the state score comprises:
training the state score machine-learning model using an initial training set derived from state representations associated with the plurality of system stages;
identifying, after the training, state representations that are incorrectly scored by the state score machine-learning model;
generating an updated training set that comprises the initially used training set and the incorrectly scored state representations; and
retraining the state score machine-learning model using the updated training set.

5. The apparatus of claim 1, wherein controlling the at least one system operation further comprises:
generating a viability graph as a function of the state distance, wherein the viability graph comprises a plurality of nodes corresponding to the plurality of system stages and one or more edges representing the state distance between the plurality of system stages; and
displaying the viability graph within the visual interface.

6. The apparatus of claim 1, wherein controlling the at least one system operation further comprises:
evaluating the state distance against one or more processing conditions; and
in response to the state distance satisfying the one or more processing conditions, triggering execution of a secondary machine-learning model configured to generate a viability coaching plan data structure as a function of the state score and the state distance.

7. The apparatus of claim 1, wherein controlling the configuration of the visual interface comprises dynamically modifying layout, ordering, and visibility of visual elements within the visual interface as a function of the state distance.

8. The apparatus of claim 1, wherein controlling the configuration of the visual interface comprises:
providing a visual summary associated with the plurality of system stages;
determining a subset of information as a function of the state distance;
selectively presenting, within the visual summary, the subset of information corresponding to the plurality of system stages; and
enabling interaction with the subset of information to cause initiation of processing associated with a selected system stage of the plurality of system stages.

9. The apparatus of claim 1, wherein controlling the configuration of the visual interface comprises:
detecting a display condition in which information associated with the plurality of system stages is at least partially visually constrained; and
reconfiguring presentation of the information associated with the plurality of system stages to an alternative visual arrangement that maintains visibility.

10. The apparatus of claim 1, wherein controlling the at least one system operation further comprises:
detecting that a computing device associated with a user is in an inactive network state;
generating and transmitting, using a communication channel, a system-generated notification as a function of the state distance; and
upon the computing device transitioning to an active network state from the inactive network state, automatically activating the visual interface to present information associated with the state distance and enable network access to additional system data.

11. A method of controlling operation of a computing system, wherein the method comprises:
obtaining, using at least a processor, input data associated with a plurality of system stages, wherein the plurality of system stages comprises a now stage and at least one goal stage;
generating, using the at least a processor and for each of the plurality of system stages, a state representation comprising a fixed-dimensional state vector, wherein the fixed-dimensional state vector comprises a plurality of normalized parameters corresponding to a plurality of machine-defined state variables;
determining, using the at least a processor, a state score corresponding to each of the plurality of system stages as a function of the fixed-dimensional state vector associated with each of the plurality of system stages using a state score machine-learning model;
determining, using the at least a processor, a state distance between at least two system stages based on a comparison of the state scores of the plurality of system stages; and
controlling, using the at least a processor, at least a system operation as a function of the state distance, wherein the at least a system operation comprises controlling configuration of a visual interface.

12. The method of claim 11, wherein the input data comprises a user profile associated with information corresponding to the now stage.

13. The method of claim 11, wherein generating the state representation comprises:
storing the fixed-dimensional state vector in a memory as an internal data structure; and
maintaining the fixed-dimensional state vector for repeated comparison of system stages without regenerating the state representation.

14. The method of claim 11, wherein determining the state score comprises:
training the state score machine-learning model using an initial training set derived from state representations associated with the plurality of system stages;
identifying, after the training, state representations that are incorrectly scored by the state score machine-learning model;
generating an updated training set that comprises the initially used training set and the incorrectly scored state representations; and
retraining the state score machine-learning model using the updated training set.

15. The method of claim 11, wherein controlling the at least one system operation further comprises:
generating a viability graph as a function of the state distance, wherein the viability graph comprises a plurality of nodes corresponding to the plurality of system stages and one or more edges representing the state distance between the plurality of system stages; and
displaying the viability graph within the visual interface.

16. The method of claim 11, wherein controlling the at least one system operation further comprises:
evaluating the state distance against one or more processing conditions; and
in response to the state distance satisfying the one or more processing conditions, triggering execution of a secondary machine-learning model configured to generate a viability coaching plan data structure as a function of the state score and the state distance.

17. The method of claim 11, wherein controlling the configuration of the visual interface comprises dynamically modifying layout, ordering, and visibility of visual elements within the visual interface as a function of the state distance.

18. The method of claim 11, wherein controlling the configuration of the visual interface comprises:
providing a visual summary associated with the plurality of system stages;
determining a subset of information as a function of the state distance;
selectively presenting, within the visual summary, the subset of information corresponding to the plurality of system stages; and
enabling interaction with the subset of information to cause initiation of processing associated with a selected system stage of the plurality of system stages.

19. The method of claim 11, wherein controlling the configuration of the visual interface comprises:
detecting a display condition in which information associated with the plurality of system stages is at least partially visually constrained; and
reconfiguring presentation of the information associated with the plurality of system stages to an alternative visual arrangement that maintains visibility.

20. The method of claim 11, wherein controlling the at least one system operation further comprises:
detecting that a computing device associated with a user is in an inactive network state;
generating and transmitting, using a communication channel, a system-generated notification as a function of the state distance; and
upon the computing device transitioning to an active network state from the inactive network state, automatically activating the visual interface to present information associated with the state distance and enable network access to additional system data.
